(19) United States
(12) Patent Application Publication
(10) Pub. No.: US 2008/0193590 A1
(43) Pub. Date: Aug. 14, 2008

(54) Highly refined cellulose neutraceutical compostions and methods of use

(75) Inventor: Brock Lundberg, Roberts, WI (US)

Correspondence Address: Mark A. Litman & Associates, P.A., York Business Center, Suite 205, 3209 West 76th St., Edina, MN, 55435, US

(73) Assignee: Fiberstar Inc., Incorporated

(21) Appl. No.: 12/148,381

(22) Filed: Apr. 18, 2008

Related U.S. Application Data
(63) Continuation-in-part of application No. 11/165,430, filed on Jun. 23, 2005.
Application No. 11/165,430 is a continuation-in-part of application No. 10/969,805, filed on Oct. 20, 2004.
Application No. 10/969,805 is a continuation-in-part of application No. 10/288,793, filed on Nov. 6, 2002, now Pat. No. 7,094,317.
(60) Provisional application No. 60/926,236, filed on Apr. 25, 2007.

(51) Int. Cl. A23L 1/10; A23L 1/29

(52) U.S. Cl. 426/2; 426/618; 426/541; 426/623

(57) ABSTRACT

A highly refined cellulose material is a composition of matter is used as an ingredient in the preparation of a neutraceutical in liquid, solid, or tablet form. These compositions may provide an expectation of a health benefit selected from the group consisting of Antioxidation; Cancer prevention; Arterial health improvement; Cholesterol lowering; Reduced blood pressure; Skin and wrinkle treatment; and Prolonging and/or delaying release of a nutrient into a bloodstream.

### RELATED APPLICATIONS DATA

This application claims priority from U.S. Provisional Application Ser. No. 60/926,236, filed 25 Apr. 2007. This application is also a continuation-in part of U.S. patent application Ser. No. 11/165,430, filed Jun. 30, 2005, titled “REDUCED FAT SHORTENING, ROLL-IN, AND SPREADS USING CITRUS FIBER INGREDIENTS,” which is a continuation-in-part of U.S. patent application Ser. No. 10/969,805, filed 20 Oct. 2004, and titled “HIGHLY REFINED CELLULOSIC MATERIALS COMBINED WITH HYDROCOLLOIDS,” which is a continuation-in-part of U.S. patent application Ser. No. 10/288,793, filed Nov. 6, 2002, titled “HIGHLY REFINED FIBER MASS, PROCESS OF THEIR MANUFACTURE AND PRODUCTS CONTAINING THE FIBERS,” now U.S. Pat. No. 7,094,317.

### BACKGROUND OF THE INVENTION

1. Field of the Invention

The present invention relates to the field of nutraceutical additives and their addition to ingestible products, such as beverages, processed foods, baked or deep-fried goods for human or other animal consumption, particularly nutraceutical additives that are recognized as having unique biological affects and benefits, while maintaining perceived taste and sensory quality in the product.

2. Background of the Art

Published articles from FDA, American Heart Association, and Harvard all tie a link between trans fats and saturated fats with increased LDL (bad cholesterol) and thus, heart disease. In January 2006, FDA required food companies to list the amount of trans fatty acids on their labels. To lower the trans fat levels in foods, shortening suppliers have introduced low trans fat shortenings. However, within the newer compositions that have been provided for low trans shortenings there is an increase in the amount of saturated fats. In a typical shortening the saturated fat goes from 26% in standard shortening to 40% in low trans shortenings. Therefore, while shortening suppliers are trying to offer a healthier product a product with lower the trans fat, there is a trade-off with the increased saturated fats that raises concerns with regard to the saturated fat ingredient. For companies concerned about keeping trans fats off their labels, a company that switches to a low trans/higher saturated fat shortening for certain high fat products, e.g., cakes, donuts, etc, will still need to label an amount of trans fatty acids and also indicate a higher level of saturated fats. This patent application targets food materials that can be used for disease prevention.

U.S. Pat. Nos. 6,251,458; 5,487,419; 4,923,981; 4,831,127; 4,629,575, Weibel) relates to material additives. U.S. Pat. No. 4,923,981 relates more to issues of fat replacement describes using expanded parenchymal cell cellulose (PCC) for fat reduction.

U.S. Pat. No. 5,964,983 (Dinand) uses alkaline and/or acid conditions to make their microfibrillated cellulose. Dinand discloses the use of alkaline and/or acid conditions to make microfibrillated cellulose, and also does not disclose the combination of water, fiber and shortening directly together to make a reduced fat shortening, oil, margarine, or butter.

U.S. Pat. No. 5,766,662 (Inglett) describes replacing fat, but specifically states that the fat replacement product is the product made according to his invention is a product made through the combination of mechanical and chemical processes.

In considering the Weibel patents (U.S. Pat. Nos. 6,251,458; 5,487,419; 4,923,981; 4,831,127; and 4,629,575), only U.S. Pat. No. 4,923,981 appears to have disclosure with respect to fat replacement using expanded parenchymal cell cellulose (PCC) for fat reduction. The resulting product is not a reduced fat shortening, spread, roll-in, butter, or oil, but is a compounded product. Additionally, this patent specifically talks about making PCC through a process that uses alkaline or acid conditions. Weibel does not disclose using a dried and expanded PCC

Lignin removal from cellulose is currently accomplished using extremely high temperatures and pressures. These extreme conditions cause raw material fragments to break apart, thus releasing the desired cellulose-based micro fibers. In addition, the raw materials are subjected to high concentrations of sodium hydroxide. See, for example, U.S. Pat. No. 5,817,381 to Chen, et al. Such a process is extremely energy-intensive in terms of the required temperatures and pressures. Further, the process produces a waste stream regarded as hazardous due to elevated pH levels caused by the use of large amounts of sodium hydroxide. Treatment of the waste stream adds to the cost of production and impacts the overall efficiency of this process.

An improvement in that process by Lundberg et al. (U.S. patent application Ser. No. 09/432,945) comprises a method for refining cellulose, the process comprising soaking raw material in NaOH having a concentration of about five (5) to 50% (dry basis) to produce soaked raw material which steeps for about 6 hours to allow the NaOH to work, refining the soaked raw material to produce refined material, dispersing the refined material to produce dispersed refined material, and homogenizing the dispersed refined material to produce highly refined cellulose (HRC) gel having a lignin concentration of at least about one (1) % and a water retention capacity (WRC) of about 25 to at least about 56 g H.sub.2O/g dry HRC. The method of the Lundberg et al invention produces a waste stream having a pH within a range of 8 to 9 and a reduced volume as compared to conventional cellulose refining processes. In one embodiment, the method further comprises draining and washing the soaked raw material until the pH is down to about 8 to 9, bleaching the washed material at a temperature of about 20 to 100° C. in hydrogen peroxide having a concentration of about one (1) to 20% dry basis, and washing and filtering the bleached material to produce a filtered material having a solids content of about thirty percent (30%) The filtered material may be refined by being passed through a plate refiner. The plate refiner essentially breaks up the lignin as it shreds the material into refined cellulose particles. The method of that invention is asserted to be energy efficient because it does not require high pressures and temperatures as in prior art processes. Despite the presence of higher lignin concentrations in the final product, the HRC gel of the Lundberg et al invention has a water holding capacity that is at least as good or better than prior art products. Use of a plate refiner to break up the lignin rather than using high concentrations of NaOH has the added advantage of producing a non-hazardous waste stream having pH within a range of 8 to 9 and a reduced volume.

U.S. Pat. No. 6,083,582 describes a process and materials are described in which highly refined cellulose fibers are broken down into microfibers and further processed into compositions, films, coatings and solid materials which are biodegradable and even edible. The process for the formation of hardenable compositions may comprise providing a composition comprising highly refined non-wood cellulose fiber, mechanically reducing the size of the non-wood cellulose fiber to less than 2 mm, reducing the amount of binding of microfibers by lignin within said non-wood cellulose fibers present in said composition comprising cellulose fiber to form a first fiber product, providing pressure of at least 300 psi to said first fiber product while it is in the presence of a liquid, and removing said pressure within a time interval which will cause said cellulose fiber to break down into a second fiber product comprising microfibers in said liquid. The patent describes edible foodstuff wherein material having nutritional value is coated, wrapped or coated and wrapped with a film of material made from the fibers of the patent.

U.S. Pat. No. 6,231,913 describes a pre-emulsion fiber composition (i.e., the mixture formed from an oil and mixture that can be formed into an oil-in-water emulsion using standard emulsification equipment known by those of skill in the art, such as a high-pressure, ultrasonic, or other homogenizer, a rotator/stator device, and like equipment. The pressure employed, the shear rate, and/or the time of emulsification may vary widely depending upon the particular equipment employed. The pressure employed when homogenizers are used for the emulsification will generally range from about 130 psi to about 220 psi, with about 180 psi being preferred. When equipment other than homogenizers is used for the emulsification, the shear rate employed will generally range from about 9,000 to about 100,000 reciprocal seconds. The emulsification time will generally range from about 1 second to about 10 minutes, but may be higher, depending upon whether the emulsification is performed in a single pass, or in multiple passes, and will more usually range from about 2 seconds to about 30 seconds.

U.S. Pat. No. 6,689,405—discloses a co-processed product containing a combination of microfibrillated cellulose (MFC, as described by U.S. Pat. No. 4,378,381, Turbak et al.) or microcrystalline cellulose (MCC) and xanthan gum or carboxymethylcellulose. They describe a co-processed gum and MCC or MFC that is sheared together, followed by spray drying. The combined product is noted for its fat like substitute for use in various foodstuffs. An important property of the dry product is that it can be rehydrated in water and be used as a fat replacer in salad dressings, dairy products such as frozen desserts, frostings, soups, spreads, fillings, candies, etc.

U.S. Pat. No. 6,495,190—describes a cellulose composite material composed of a fine cellulose and 1-80% by weight of at least one low-viscosity water-soluble dietary fiber selected from the group consisting of 1) a hydrolyzed galactomannan, and 2) an indigestible dextrin or a mixture of a polydextrose and xanthan gum and/or gellan gum. The cellulose-containing composite comprising a particular fine cellulose and a low-viscosity water-soluble dietary fiber has a superior mouth-feel and fluidity when used as a dietary fiber or as an oil and fat substitute. The composite is obtained by mixing the fine cellulose and a low-viscosity water-soluble dietary fiber in a wet state, e.g. a slurry, paste, gel or cake, and drying the wet mixture. All references cited herein, including within the claim for priority, are incorporated herein in their entirety.

### SUMMARY OF THE INVENTION

A highly refined cellulose material, defined by a fiber material that has a total dietary fiber (TDF) content greater than 30% as measured by AOAC 991.43 and a water holding capacity greater than five parts water per part fiber as measured by AACC 56-30 followed literally or with modifications as listed in the specifications and is less than 90% soluble fiber, used as a carrier for nutraceuticals, either as a mixture, blend, bound particles (with or without additional binder), dispersion, suspension, emulsion or other medium that will support both the HRC and the nutraceutical additive. The nutraceutical food additive may be a separate additive or in combination with natural gums, such as xanthan, karrageenan, guar guar, agar, maltodextrin, gum Arabic, alpha, beta, gamma, delta and kappa.-carrageenan, iota-carrageenan, 50/25/25. kappa.-carrageenan, xanthan gum and locust bean gum and the like (all natural and synthetic thermoreversible gums), in proportions of 5 to 50% fiber by weight of the mixture of fiber and gum, that is by total weight of the two materials. This nutraceutical material is relatively storage stable in its own right and assists in the retention of moisture without change of taste or feel in final products, such as processed foods, grain-based solid foods, gels, creams, purees, beverages, cooked meats, casseroles, and the like.

### DETAILED DESCRIPTION OF THE INVENTION

The present technology describes compositions and materials for the delivery of biologically beneficial agents, generally referred to as “Nutraceuticals” for ingestion by patients such as people and animals. Nutraceuticals, are foods or bioactive ingredients in foods that protect or promote health whether delivered in raw agricultural commodities, processed foods, dietary supplements, extracts, beverages or other products and occurs at the intersection of food and pharmaceutical industries. The development of next generation nutraceutical “super foods” or products consiss oft value-addition in the traditional natural diets. Their ingredients have tremendous impact on the health care system and may provide medical health benefits including the prevention and or treatment of diseases. Nutraceuticals have potential to be used as food supplement, preventive medicine and the growing evidence points in the direction that certain foods fight and or prevent against diseases.

The word Nutraceuticals combine ‘nutrition’ and ‘pharmaceuticals’ to mean that they can be used as preventive drugs or food supplements. The entire concept is based on the disease preventing/treating phytonutrients present in foodstuffs of the diet in combating diseases e.g. phytosterols compete with dietary cholesterol for uptake in intestine thereby blocking cholesterol absorption into the body and can also prevent the development of tumor in breast and prostate glands. Phenols a large group of phytonutrients, have profound importance in preventive medicine. Phytochemicals can enhance the efficacy of vitamin C, can also act against allergies, ulcers, tumors, platelet aggregation, controlling hypertension and reduce the risk of estrogen induced cancer. Well known classes of nutraceuticals include, as non-limiting examples:
a. plant stanol esters/plant sterols
b. beta-glucan
c. omega-3 oils
d. isoprenoids
e. isoflavonoids
f. anticancer compounds, e.g. sulforaphane.
g. Tocopheryls

h. Vitamins (A, Bₙ, C, D, E, K etc.)

The Expanded fiber materials or HRCs that may be used in the practice of the present technology include at least the following selection of disclosed and/or commercially available fiber materials as from about 0.05%-5% by total weight highly refined cellulose product defined by a fiber material that has a total dietary fiber (TDF) content greater than 30% as measured by AOAC 991.43 and a water holding capacity greater than five parts water per part fiber as measured by AACC 56-30 and comprises less than 90% soluble fiber.

Examples of commercial products or disclosed products and their method of manufacture include, by way of non-limiting examples, and as disclosed in background references cited above, which are incorporated herein by reference, include at least:
i. Citri-Fi 100® citrus fiber
ii. Citri-Fi 100FG® citrus fiber
iii. Citri-Fi 100M40® citrus fiber
iv. Citri-Fi 200® citrus fiber and guar gum
v. Citri-Fi 200FG® citrus fiber and guar gum
vi. Citri-Fi 300FG® citrus fiber and xanthan gum
vii. Z-trim™ products
viii. Products made according to U.S. Pat. Nos. 4,378,381, 4,374,702. (Turbak)
ix. Products made according to U.S. Pat. No. 4,481,076 (Herrick)
x. Products made according to Published US Patent Application Publication No. 20060115564.
   Nutraceuticals have been cited for at least some of the following health benefits:
a. Antioxidant
b. Cancer prevention
c. Arterial health improvement
d. Cholesterol lowering
e. Reduced blood pressure
f. Skin and wrinkle treatment.

Nutraceuticals usually are not suggested as curing ailments, but rather as for treating the symptoms of colds, flu, allergies, or sinus discomfort as well as treating pain and discomfort associated with heartburn, general body aches, headaches, migraines, menstruation, joint discomfort and arthritis, which may include other pharmaceutical ingredients, preferably selected from a group which includes, for example, acetaminophen, acetylsalicylic acid or an effective salt thereof, ibuprofen, ketoprofen, naproxen, naprosyn phenylpropanolamine bitartarate or an effective salt thereof, pseudoephedrine hydrochloride or an effective salt thereof, diphenhydramine hydrochloride or an effective salt thereof, clemastine fumarate or an effective salt thereof, chlorpheniramine maleate or an effective salt thereof, bromopheniramine maleate or an effective salt thereof, guaifenesin, dextromethorphan hydrochloride or an effective salt thereof, dextromethorphan hydrobromide or an effective salt thereof, famostidine, ranitidine, cimetidine, phenindamine tartarate or an effective salt thereof, calcium carbonate or an effective salt thereof, and combinations thereof. The nutraceutical ingredients may be preferably selected from the group which includes, for example, Echinacea purpurea, Echinacea angustifolia, Echinacea pillida, Gingko biloba, saw palmetto, ginseng, cat's claw (una de gato), cayenne, bilberry, cranberry, grapeseed extract, St. john's wort, cascara sagrada, valerian, elderberry, elder flower, sweet elder, Sambucous nigra, Sambucous canadensis, garlic, Camellia sinensis, Camellia thea, Camellia theifera, Thea sinensis, Thea bohea, Thea viridis, goldenseal, wild cherry (Rosacea), quercetin, stinging nettles (Urtica), curcumin, bromelain, multiple pancreatic enzymes (protease, protease II, protease m, peptidase, amylase, lipase, cellulase, maltase, lactase, invertase), Emblica officinalis, eicosapentaenoic acid, docosahexaeonic acid, primrose oil, feverfew, ginger root, vitamin E (D-alpha-tocopherol), licorice root (Glycyrrhiza uralensis), aloe vera, horseradish root, L-glutamine, ascorbic acid, antiscorbutic vitamin, rose hips, calcium ascorbate, cevitamic acid, citrus bioflavonoids complex, acerola, zinc or an effective salt thereof, Astragalus membranaceous, Astragalus mongolicus, membranous milk vetch, milk vetch, mongolian milk, dong quai, huangqi, hunag qi, moring a and combinations thereof. Although these ingredients are preferred, other pharmaceuticals and nutraceuticals may be substituted in their place.

A highly refined cellulose material is a composition of matter is defined in variously in the art by way of its properties. For example, copending U.S. patent application Ser. No. 10/303,256 describes HRC fibers as cellulosic mass from organic mass derived from agricultural plants comprising a highly refined cellulose (HRC) having a lignin concentration of at least 1% by weight and a water retention capacity of at least about 20 g H₂O/g dry HRC, possibly an oil retention capacity of at least about 10 g/g dry HRC, and possibly further having an oil retention capacity of at least about 10 g/g dry HRC and or a Langmuir surface area of at least about 7 m²/g. The HRC may have an average pore diameter of at least about 5 angstroms and may have a Langmuir surface area of at least about 7 m²/g. That reference is incorporated herein in its entirety.

HRC material may alternatively be described as a fiber material that has a total dietary fiber (TDF) content greater than 30% as measured by AOAC 991.43 and a water holding capacity greater than five parts water per part fiber as measured by AACC 56-30 followed literally or with modifications as listed in the specifications and is less than 90% soluble fiber.

The HRC may, according to the practices of the technology described herein, be used as an ingredient in the preparation of non-leavened or leavened, vegetarian or meat-containing product that is prepared by baking, frying, broiling or other heated-prepared methods, the precooked mass comprising 0.05%-5.0% by weight of highly refined cellulose fiber or 0.01%-10% by total weight of the food product of the fiber gum combination. The combination of the fiber and gum is preferably made in advance of the mixture of the fiber/gum composition to the food product, which in part explains the relatively wide range of weight additions of these materials that is possible. When the fiber ad gum materials are precombined, in the 5-50% range described above, preferably in a

Highly refined cellulose fibers may be produced with a wide range of properties and by various distinct processes. For the purpose of this patent application we are defining highly refined cellulose fibers as those with a total dietary fiber (TDF) content greater than 30% as measured by AOAC 991.43 and a water holding capacity (WHC) greater than five parts water per part fiber as measured by AACC 56-30 followed literally or with the following modifications; namely, 1) using shearing to hydrate the fiber mass, and/or 2) only using the first stage steps (1-4) of AACC 56-30 to find the approximate WHC and using this as the final WHC value, and/or 3) determining the final or approximate WHC value at 2-10% solids instead of 10% or using 2.5 g of fiber mass for the sample size instead of 5 g as the procedure calls for. The varying products can produce highly refined cellulose products with a wide range of properties that are based in part upon both on the starting organic mass containing fibers and the process steps, parameters and reagents. The underlying objective of the various processes is to take fibrous and or cellular mass (usually from agricultural products, especially flora (plants), and to reduce the structure in maximum ways. For example, as the original mass is sheared, shredded, exploded, disrupted or otherwise reduced from a complete cellular structure to fibrils, fibers, particles and other structures that form parts of the original organic mass. Various references that teach such processes and resulting expanded, highly refined cellulose materials include but are not limited to U.S. Pat. Nos. 5,766,662; 5,342,636; 4,957,599; and copending U.S. patent application Ser. No. 10/969,805, filed 20 Oct. 2004, “HIGHLY REFINED CELLULOSIC MATERIALS COMBINED WITH HYDROCOLLOIDS,” which is a continuation-in-part of U.S. patent application Ser. No. 10/288,793, filed Nov. 6, 2002, titled “HIGHLY REFINED FIBER MASS, PROCESS OF THEIR MANUFACTURE AND PRODUCTS CONTAINING THE FIBERS.”

It is important to note the difference ion the practice of the present technology of the term “highly refined cellulose” product as compared to the more conventional material referred to as “dietary fiber.” Many teachings of baked products including cracker products include the use of dietary fiber as one method of improving dietary or nutritional benefits in the baked good. Dietary fiber generally refers to the use of bulk fiber material, usually in its less processed state (e.g., dried but not highly sheared) so that the fiber remains substantially intact and even cell wall structure and cell morphology can be readily seen under microscopic examination (e.g., 40× to 500× examination).

Published U.S. Patent Applications Nos. 20050274469; 20050271790; 20050074542; 20040086626; and 20030116289 disclose highly refined cellulose materials.

Prior art results according to the Chen patents were WRC values were measured for both the aqueous HRC gel and dried HRC powder using a process that used NaOH concentrations ranging from about 0.004 to 0.025 g NaOH/g water. The WRC values for both the HRC gel and HRC powder were in the range of about 20 to at least about 56 g H₂O/g dry HRC, depending on the concentration of the alkaline solutions as measured by AACC 56-10 at varying solids content, which were typically less than 5% and most commonly at 1%. Maximum WRC values for the gel of at least about 56 g H₂O/g dry HRC were obtained with a NaOH concentration of about 0.007 g NaOH/g H.sub.2O. Drying the HRC gel resulted in a reduction of about three (3) to 15% in WRC, which may be attributed to structural damages such as recrystallization caused by dehydration. However, the HRC powder also exhibited high WRC values, having a maximum WRC value of at least about 56 g H₂O/g dry HRC at a NaOH concentration of about 0.007 g NaOH/g H₂O. Compared with WRC values for even earlier prior art HRC products of 3.5 to 10 g water/g dry powdered cellulose reported by Ang and Miller in Cereal Foods World, Multiple Functions of Powdered Cellulose as a Food Ingredient, Vol. 36 (7): 558-564 (1991), it was shown that both the HRC gel and powder of the Chen Patents had a much higher water-holding capacity than prior art materials known at the time of the invention.

Determination of Water-Retention Capacity (WRC) and Oil-Retention Capacity (ORC) WRC is a measure of the amount of water retained under standard centrifuge. The WRC values for both aqueous HRC gel and freeze-dried HRC were determined in accordance with Method 56-10 of the American Association of Cereal Chemists (AACC), except the water holding capacities were measured in a 1% hydrated state. In the ORC (oil retention capacity) test, the same procedure was used except oil was used instead of water.

Determination of Pore Size and Microsurface Area Both the pore size and the microsurface area of freeze-dried HRC samples were measured using a Micromeritics™ 2000 from Micromeritice Instrument Co. The test sample was weighed with a precision of 0.0001 g. In all cases, the test sample weight was more than 100 mg to reduce the effect of weighing errors. At 85° C. and 6 mmHg vacuum, the sample was degassed, and moisture and other contaminants were removed. The degassed sample was analyzed in a nitrogen gas environment. Average pore diameter, BET surface area and Langmuir surface area were measured. The BET surface area values were determined by calculating the monolayer volume of adsorbed gas from the isotherm data. The Langmuir surface area values were obtained by relating the surface area to the volume of gas adsorbed as a monolayer.

Results and Discussion—Pore Size and Surface Area

Average pore size is a measure of openness of the HRC structure. The average pore size increased rapidly as NaOH concentration was increased to 0.007%, then slowly with further increase in NaOH concentration. The surface area reached a maximum value at 0.007% NaOH, which also coincides with the maximum WRC discussed above. The decrease in surface area after the maximum value seems to suggest an increase in the ratio of large pores to small pores, which may contribute to the decrease in total surface area. In one embodiment, the processes of the Lundberg Application removes lignin to a sufficient degree or substantially inactivates it such that undesirable fiber clumping does not occur There is not a large apparent difference in terms of WHC/viscosity between the two products (the Chen product and the product of the Lundberg Application) in a wet form, but there is a significant and commercially and technically important difference between the products/processes is that 1) Chen never provided a method for drying the gel product or 2) rehydrating the dry product. Additionally, 3) the present process for citrus has no required chemical treatment and does not need any mechanical treatments to produce a dry product that rehydrates to a high WHC/viscosity gel. Additionally, there is less concern about all the surface area, and pore size measurements.

It is desired that the highly refined cellulose fiber materials used in the practice of the present technology have the following properties. The HRC materials should provide a viscosity of at least 200 cps (preferably at least 300 cps) at 20 C in a concentration of 3% in deionized water after mild stirring for 4 hours, a water retention capacity of at least 8× the dry weight of fiber (preferably at least 10×, at least 15× and at least 20×), which may also be determined by filtering saturated fiber mass, draining excess water (e.g., under mild pressure of 50 g/10 cm² for three minutes), weighing the drained wet fiber mass, then dehydrating the drained mass (to less than 5% water retention/weight of the fiber) and weighing the dried product to determine the amount of absorbed water removed. This latter method is less preferred, but can address the issue that drying of fibers often changes their physical properties, and particularly dried fibers (unless additionally sheared) often lose WRC after drying.

A highly refined cellulosic material (e.g., cellulose, modified celluloses, derivatized celluloses, hemicellulose, lignin, etc.) product can be prepared by generally moderate treatment and still provide properties that are equivalent to or improved upon the properties of the best highly refined cellulose products produced from more intense and environmentally unfriendly processes. Fruit or vegetable cells with an exclusively parenchymal cell wall structure can be treated with a generally mild process to form highly absorbent microfibers. Cells from citrus fruit and sugar beets are particularly available in large volumes to allow volume processing to generate highly refined cellulose fibers with both unique and improved properties. These exclusively parenchymal microfibers (hereinafter referred to as EPM's) have improved moisture retention and thickening properties that enable the fibers to provide unique benefits when combined into edible products (e.g., baked goods, liquefied foods, whipped foods, meats, meat fillers, dairy products, yogurt, frozen food entrees, ice cream, etc.) and in mixtures that can be used to generate edible food products (e.g., baking ingredients, dehydrated or low hydration products).

A new process for making HRC cellulose from parenchyma cell wall products, e.g. citrus fruit and sugar beets by-products, is performed in the absence of a hydroxide soaking step. This is a significant advance over the prior art as described by the Chen and Lundberg patents. Dinand, et al. (U.S. Pat. No. 5,964,983) also recommends the use of a chemical treatment step in addition to bleaching. In the present invention we are able to attain higher functionality (measured as viscosity) compared to Dinand et al. even though we use less chemical treatment, which is likely due to the higher amount of shear and chemical energy we put into the materials. The product is able to display the same or improved water retention properties and physical properties of the more strenuously refined agricultural products of the prior art, and in some cases can provide even higher water retention values, thickening and other properties that can produce unique benefits in particular fields of use.

General descriptions of the invention include a highly refined cellulose product comprising microfibers derived from organic fiber plant mass comprising at least 50% by weight of all fiber mass as parenchymal fiber mass, the highly refined cellulose product having an alkaline water retention capacity of at least about 25 g H₂O/g dry highly refined cellulose product and methods for providing and using these products. The highly refined cellulose product may have a water retention capacity of at least 50 g H₂O/g dry highly refined cellulose product.

Parenchymal cell walls refer to the soft or succulent tissue, which is the most abundant cell wall type in edible plants. For instance, in sugar beets, the parenchyma cells are the most abundant tissue the surrounds the secondary vascular tissues (xylem and phloem). Parenchymal cell walls contain relatively thin cell walls compared to secondary cell walls are tied together by pectin (Haard and Chism, 1996, Food Chemistry. Ed. by Fennema. Marcel Dekker NY, N.Y.) In secondary cell walls (xylem and phloem tissues), the cell walls are much thicker than parenchymal cells and are linked together with lignin (Smook). This terminology is well understood in the art.

As used in the practice of the present invention, the term “dry” or “dry product” refers to a mass that contains less than 15% by weight of fibers as water. The organic fiber mass comprises at least 50% by weight of fiber mass from organic products selected from the group consisting of sugar beets, citrus fruit, grapes, tomatoes, chicory, potatoes, pineapple, apple, carrots and cranberries. A food product or food additive may have at least 0.05 percent by weight solids in the food product or food additive of the above described highly refined cellulose product. The food product may also have at least about one percent or at least about two percent by weight of the highly refined cellulosic fiber of the invention.

A method for refining cellulosic material may comprise:

soaking raw material from organic fiber plant mass comprising at least 50% by weight of all fiber mass as parenchymal fiber mass in an aqueous solution with less than 1% NaOH;

draining the raw material and allowing the raw material to sit for a sufficient period under conditions (including ambient conditions of room temperature and pressure as well as accelerated conditions) so that the fibers and cells are softened so that shearing can open up the fibers to at least 40%, at least 50%, at least 60%, or at least 70, 80, 90 or 95% of their theoretic potential. This will usually require more that 4 hours soaking to attain this range of their theoretic potential. It is preferred that this soaking is for more than 5 hours, and preferably for at least about 6 hours. This soaking time is critical to get the materials to fully soften. When such a low alkaline concentration is used in the soaking, without the set time, the materials do not completely soften and can not be sheared/opened up to their full potential. This process produces soaked raw materials; and the process continues with refining the soaked raw material to produce refined material; and drying the soaked raw material.

The process may perform drying by many different commercial methods, although some display improved performance in the practice of the present invention. It is preferred that drying is performed, at least in part, by fluid bed drying or flash drying or a combination of the two. An alternative drying process or another associated drying step is performed at least in part by tray drying. For example, fluid bed drying may be performed by adding a first stream of organic fiber plant mass and a second stream of organic fiber plant mass into the drier, the first stream having a moisture content that is at least 10% less than the moisture content of the second stream or organic fiber plant mass. The use of greater differences in moisture content (e.g., at least 15%, at least 20%, at least 25%, at least 40%, at least 50% weight-to-weight water percent or weight-to-weight water-to-solid percent) is also within the scope of practice of the invention. In the drying method, the water may be extracted with an organic solvent prior to drying. In the two stream drying process, the second stream of organic fiber plant mass may have at least 25% water to solids content and the first stream may have less than 15% water to solids content. These processes may be practiced as batch or continuous processes. The method may use chopping and washing of the cellulose mass prior to soaking.

Another description of a useful process according to the invention may include draining and washing the soaked raw material in wash water to produce washed material; bleaching the washed material in hydrogen peroxide to produce a bleached material; and washing and filtering the bleached material to produce a filtered material.

The drying of an expanded fiber material according to the invention may use room temperature or higher air temperatures that dry the expanded fiber product and maintain the fiber material's functionalities of at least two characteristics of surface area, hydrogen bonding, water holding capacity and viscosity. It is also useful to use backmixing or evaporating to bring the organic fiber plant mass to a solids/water ratio that will fluidize in air in a fluid bed air dryer. This can be particularly performed with a method that uses a fluid bed dryer or flash dryer to dry the expanded or highly refined cellulosic fiber product.

The use of a flash or fluid bed dryer is an advantage over the drying methods suggested by Dinand et al. We have found that through the use of a fluid bed or flash dryer, low temperatures and controlled humidity are not needed to dry the materials of the present invention. In fact, although nearly any drying temperature in the fluid bed or flash dryer can be used, we have dried the product of the present invention using high air temperatures (400 F) and attained a dry product with near equivalent functional properties after rehydration compared to the materials before drying. Additionally, using the process of the present invention, any surface area expanded cellulosic product can be dried and a functional product obtained and is not limited to parenchyma cell wall materials. The use of a fluid bed or flash dryer, the use of relatively high drying air temperatures (400 F+), and the ability to dry non parenchyma cell wall (secondary cell) and obtain a functional product is in great contrast to the relatively low temperatures, e.g. 100 C (212 F) and dryer types taught by Dinand et al to dry expanded parenchymal cell wall materials.

The University of Minnesota patent application (Lundberg et al), describes the ability to obtain a functional dried product. However, the only way they were able to obtain a functional dry product was through freeze drying (Gu et al, 2001).—from (Gu, L., R Ruan, P. Chen, W. Wilcke, P. Addis. 2001. Structure Function Relationships of Highly Refined Cellulose. Transactions of the ASAE. Vol 44(6). 1707-1712). Freeze drying is not an economically feasible drying operation for large volumes of expanded cell wall products.

The fiber products of the invention may be rehydrated or partially rehydrated so that the highly refined cellulose product is rehydrated to a level of less than 90 g H₂O/g fiber mass, 70 g H₂O/g fiber mass, 50 g H₂O/g fiber mass or rehydrated to a level of less than 30 g H₂O/g fiber mass or less than 20 g H₂O/g fiber mass. This rehydration process adjusts the functionalities of the product within a target range of at least one property selected from the group consisting of water holding capacity, oil holding capacity, and viscosity and may include the use of a high shear mixer to rapidly disperse organic fiber plant mass materials in a solution. Also the method may include rehydration with soaking of the dry materials in a solution with or without gentle agitation.

Preferred areas of use include a bakery product to which at least 1% by weight of the organic fiber product of the invention is present in the bakery product. The process may enhance the stability of a bakery product by adding at least 1% by weight of the product of claim to the bakery product, usually in a range of from 1% to 10% by weight of the organic fiber plant mass product to the bakery product prior to baking and then baking the bakery product. This process may include increasing the storage stability of a flour-based bakery product comprising adding from 1% to 10% by weight of the highly refined organic fiber plant mass product 1 to the bakery product prior to baking and then baking the bakery product.

The basic process of the invention may be generally described as providing novel and improved fiber waste by-product from citrus fruit pulp (not the wood and stem and leaves of the trees or plant, but from the fruit, both pulp and skin) or fiber from sugar beet, tomatoes, chicory, potatoes, pineapple, apple, cranberries, grapes, carrots and the like (also exclusive of the stems, and leaves). The provided fiber mass is then optionally soaked in water or aqueous solution (preferably in the absence of sufficient metal or metallic hydroxides e.g., KOH, CaOH, LiOH and NaOH) as would raised the pH to above 9.5, preferably in the complete absence of such hydroxides (definitely less than 3.0%, less than 1.0%, more often less than 0.9%, less than 0.7%, less than 0.5%, less than 0.3%, less than 0.1%). The soaked material is then drained and optionally washed with water. This is optionally followed by a bleaching step (any bleaching agent may be used, but mild bleaching agents that will not destroy the entire physical structure of the fiber material is to be used (with hydrogen peroxide a preferred example, as well as mild chlorine bleaches). It has also been found that the bleach step is optional, but that some products require less color content and require bleaching. The (optionally) bleached material is washed and filtered before optionally being subjected to a shredding machine, such as a plate refiner which shreds the material into micro fibers. The optionally soaked, bleached, and refined material is then optionally dispersed, and homogenized at high pressure to produce HRC gel.

The HRC dispersion of the present invention is a highly viscous, semi-translucent gel. HRC embodiments comprise dried powders that are redispersable in water to form gel-like solutions. The functional characteristics of HRC are related to various properties, including water- and oil-retention capacity, average pore size, and surface area. These properties inherently relate to absorption characteristics, but the properties and benefits provided by the processes and products of the invention seem to relate to additional properties created in the practice of the invention.

The present invention also includes an aqueous HRC gel having a lignin concentration of about one to twenty percent (1 to 20%). The HRC products of the present invention exhibit a surprisingly high WRC in the range of about 20 to at least about 56 g H₂O/g dry HRC. This high WRC is at least as good as, and in some cases, better than the WRC of prior art products having lower or the same lignin concentrations. The HRC products exhibit some good properties for ORC (oil retention capacity).

A general starting point for a process according to the invention is to start with raw material of sufficiently small size to be processed in the initial apparatus (e.g., where soaking or washing is effected), such as a soaker or vat. The by-product may be provided directly as a result of prior processing (e.g., juice removal, sugar removal, betaine removal, or other processing that results in the fiber by-product. The process of the present invention may also begin when raw material is reduced in size (e.g., chopped, shredded, pulverized) into pieces less than or equal to about 10×5 cm or 5 cm×2 cm. Any conventional type of manual or automated size reduction apparatus (such as chopper, shredder, cutter, slicer, etc.) can be used, such as a knife or a larger commercially-sized chopper. The resulting sized raw material is then washed and drained, thus removing dirt and unwanted foreign materials. The washed and chopped raw material is then soaked. The bath is kept at a temperature of about 20 to 100° C. The temperature is maintained within this range in order to soften the material. In one embodiment, about 100 g of chopped raw material is soaked in a 2.5 liter bath within a temperature range of about 20 to 80 degrees Centigrade for 10 to 90 minutes.

The resulting soaked raw material is subjected to another washing and draining. This washing and additional washing and draining tend to be more meaningful for sugar beets, potatoes, carrots (and to some degree also tomatoes, chicory, apple, pineapple, cranberries, grapes, and the like) than for citrus material. This is because sugar beets, potatoes, carrots, growing on the ground rather than being supported in bushes and trees as are citrus products, tend to pick up more materials from the soil in which they grow. Sugar beets and carrots tend to have more persistent coloring materials (dyes, pigments, minerals, oxalates, etc.) and retained flavor that also are often desired to be removed depending upon their ultimate use. In one embodiment, the soaked raw material is washed with tap water. In one other embodiment, the material is drained. This is optionally followed by bleaching the material with hydrogen peroxide at concentrations of about one (1) to 20% (dry basis) peroxide. The bleaching step is not functionally necessary to effect the citrus and grape fiber conversion to highly refined cellulose. With respect to carrots and sugar beets, some chemical processing may be desirable, although this processing may be significantly less stressful on the fiber than the bleaching used on corn-based HRC products. From our experience, some chemical step is required for sugar beets, and bleaching is one option. Using alkaline pretreatment baths is another option. Acid treatment or another bleaching agent are other options.

The material is optionally bleached at about 20 to 100° C. for about five (5) to 200 min. The bleached material is then subjected to washing with water, followed by filtering with a screen. The screen can be any suitable size. In one embodiment, the screen has a mesh size of about 30 to 200 microns.

The filtered material containing solids can then be refined (e.g., in a plate refiner, stone mill, hammer mill, ball mill, or extruder.). In one embodiment, the filtered material entering the refiner (e.g., a plate refiner) contains about four percent (4%) solids. In another embodiment, the refining can take place in the absence of water being added. The plate refiner effectively shreds the particles to create microfibers. The plate refiner, which is also called a disk mill, comprises a main body with two ridged steel plates for grinding materials. One plate, a refining plate, is rotated while a second plate remains stationary. The plates define grooves that aid in grinding. One plate refiner is manufactured by Sprout Waldron of Muncy, Pa. and is Model 12-ICP. This plate refiner has a 60 horsepower motor that operates at 1775 rpm.

Water may be fed into the refiner to assist in keeping the solids flowing without plugging. Water assists in preventing the refiner's plates from overheating, which causes materials in the refiner to burn. (This is a concern regardless of the type of grinding or shearing device used.). The distance between the plates is adjustable on the refiner. To set refining plate distances, a numbered dial was affixed to the refining plate adjustment handle. The distance between the plates was measured with a micrometer, and the corresponding number on the dial was recorded. Several plate distances were evaluated and the setting number was recorded. A variety of flow consistencies were used in the refiner, which was adjusted by varying solids feed rate. The amount of water flowing through the refiner remained constant. Samples were sent through the refiner multiple times. In one embodiment the materials are passed one or more times through the plate refiner.

The microfibers may then be separated with a centrifuge to produce refined materials. The refined materials are then diluted in water until the solids content is about 0.5 to 37%. This material is then dispersed. In one embodiment, dispersing continues until a substantially uniform suspension is obtained, about 2 to 10 minutes. The uniform suspension reduces the likelihood of plugging.

The resulting dispersed refined materials, i.e., microparticles, may then be homogenized in any known high pressure homogenizer operating at a suitable pressure. In one embodiment, pressures greater than about 5,000 psi are used. The resulting highly refined cellulose (HRC) gel may display a lignin content of about 1 to 20% by weight, depending in part upon its original content.

The absence of use of a mild NaOH soaking before the refining step in the present invention prior to high pressure homogenization does not require the use of high temperature and high pressure cooking (high temperature means a temperature above 100 degrees C. and high pressure means a pressure above 14 psi absolute). High temperature and high pressure cooking may be used, but to the disadvantage of both economics and output of the product. This novel process further avoids the need for either mild concentrations of NaOH or of highly concentrated NaOH and the associated undesirable environmental impact of discharging waste water containing any amount of NaOH and organic compounds. The process also avoids a need for an extensive recovery system. In one embodiment, the pH of the discharge stream in the present invention is only about 8 to 9 and may even approach 7. The method of the present invention has the further advantage of reducing water usage significantly over prior art processes, using only about one third to one-half the amount of water as is used in conventional processes to produce to produce HRC gel and amounts even less than that used in the Chen processes

All of the mechanical operations, refining, centrifuging, dispersing, and homogenizing could be viewed as optional, especially in the case of citrus pulp or other tree bearing fruit pulps. Additionally, other shearing operations can be used, such as an extruder, stone mill, ball mill, hammer mill, etc. For citrus pulp, the only processes that are needed to produce the expanded cell structure are to dry (using the novel drying process) and then properly hydrate the raw material prior to the expanding and shearing step of the process of the invention. This simple process could also be used in other raw material sources.

Hydration is a term that means reconstituting the dried fiber back to a hydrated state so that it has functionality similar to the pre-dried material. Hydration can be obtained using various means. For instance, hydration can occur instantly by placing the dry products in a solution followed by shearing the mixture. Examples of shearing devices are a high shear disperser, homogenizer, blender, ball mill, extruder, or stone mill. Another means to hydrate the dry materials is to put the dry product in a solution and mix the materials for a period of time using gentle or minimal agitation. Hydrating dry materials prior to use in a recipe can also be conducted on other insoluble fibrous materials to enhance their functionality.

The initial slurry of fibers/cells from the EPM products is difficult to dry. There is even disclosure in the art (e.g., U.S. Pat. No. 4,413,017 and U.S. Pat. No. 4,232,049) that slurries of such processed products cannot be easily dried without expensive and time consuming processes (such as freeze drying, extended flat bed drying, and the like). Freeze drying is effective, but is not economically and/or commercially desirable. Similarly, tray dryers may be used, but the length of time, labor and energy requirements make the process costly. The slurries of the citrus and/or beet by-products may be dried economically and effectively according to the following practices of the invention. Any type of convective drying method can be used, including a flash dryer, fluid bed dryer, spray dryer, etc. One example of a dryer that can be used is a fluid bed dryer, with dry material being added to the slurry to equilibrate the moisture content in the materials. It has been found that by adding 5:1 to 1:1 dry to wet materials within the fluid bed drier improves the air flow within the drier and the material may be effectively dried. In the absence of the combination of “dry” and “wet” materials, the slurry will tend to merely allow air to bubble through the mass, without effective drying and without a true fluid bed flow in the drier. The terms wet and dry are, of course, somewhat relative, but can be generally regarded as wet having at least (>40% water/<60% solid content] and dry material having less than 20% water/80% solid content). The amounts are not as critical as the impact that the proportional amounts of materials and their respective water contents have in enabling fluid flow within the fluid bed drier. These ranges are estimates. It is always possible to use “wet” material with lower moisture content, but that would have to have been obtained by an earlier drying or other water removal process. For purpose of economy, and not for enabling manufacture of HRC microfibers according to the present invention from citrus or beet by-product, it is more economical to use higher moisture content fiber mass as the wet material. After the mixture of wet and dry materials have been fluid bed dried (which can be done with air at a more moderate temperature than is needed with flat bed dryers (e.g., room temperature air with low RH may be used, as well as might heated air). A flash drier may also be used alternatively or in combination with a fluid bed drier to effect moisture reduction from the citrus or beet by-product prior to produce a functional dry product. It would be necessary, of course, to control the dwell time in the flash drier to effect the appropriate amount of moisture reduction and prevent burning. These steps may be provided by the primary or source manufacturer, or the product may be provided to an intermediate consumer who will perform this drying step to the specification of the process that is intended at that stage.

One aspect of the drying process is useful for the drying of any expanded cellulose products, especially for the drying of highly refined cellulose fibers and particles that have been extremely difficult or expensive to dry. Those products have been successfully dried primarily only with freeze drying as a commercially viable process. That process is expensive and energy intense. A method according to the present invention for the drying of any expanded cellulose fiber or particle product comprises drying an expanded cellulose product by providing a first mass of expanded cellulose fiber product having a first moisture content as a weight of water per weight of fiber solids; providing a second mass of expanded cellulose fiber product having a second moisture content as a weight of water per weight of fiber solids, the second moisture content being at least 20% less than said first moisture content; combining said first mass of expanded cellulose fiber product and said second mass of expanded cellulose product to form a combined mass; drying said combined mass in a drying environment to form a dried combined mass. The method may have the dried combined mass dried to a moisture content of less than 20, less than 10, less than 8, less than 5 or less than 3H₂O/g fiber mass. The method, by way of non-limiting examples, may use drying environments selected from the group consisting of, flash driers, fluid bed driers and combinations thereof.

The rehydration and shearing (particularly high shearing at levels of at least 10,000 sec⁻¹, preferably at least 15,000 sec⁻¹, more often, greater than 20,000, greater than 30,000, greater than 40,000, and conveniently more than 50,000 sec⁻¹ (which is the actual shearing rate used in some of the examples) of the dry fiber product enables the resultant sheared fiber to retain more moisture and to retain moisture more strongly. It has been noted in the use of materials according to the practice of the invention that when the fiber products of the invention are rehydrated, the water activity level of rehydrated fiber is reduced in the fiber (and the fiber present in a further composition) as compared to free water that would be added to the further composition, such as a food product. The food products that result from cooking with 0.1 to 50% by weight of the HRC fiber product of the invention present has been found to be highly acceptable to sensory (crust character, flavor/aroma, grain/texture, taste, odor, and freshness, especially for mixes, frozen foods, baked products, meat products and most particularly for bakery goods, bakery products, and meat products) tests on the products. Importantly, the products maintain their taste and mouth feel qualities longer because of the higher moisture retention. The high water absorbency and well dispersed nature of the product also lends itself to be an efficient thickening agent/suspending agent in paints, salad dressings, processed cheeses, sauces, dairy products, meat products, and other food products.

Donuts, breads, pastry and other flour products that are deemed freshest when they are moist, tend to retain the moisture and their sensory characteristics compatible with freshness longer with the inclusion of these fibers. In bakery products, the loaf volume maintains the same with the addition of the product of the present invention.

In another embodiment, the HRC products of the present invention possess a WRC and ORC that are at least as good as or even better than prior art products (including the Chen product) with regard to the water retention characteristics and the strength of that retention. This is true even though the products of the present invention may have a higher lignin concentration than products made using conventional processes and are dried (and the same amount as the Lundberg patents products). It is assumed that the lignin which is present has been substantially inactivated to a sufficient degree so that the undesirable clumping does not subsequently occur. Another reason for these improved properties may be due to a porous network structure that is present in the HRC products of the present invention, but is lost in prior art products due to high concentration soaking in NaOH, and which may be slightly reduced even with the mild NaOH solutions used by the Lundberg Patents.

A number of unexpected properties and benefits have been provided by the highly refined cellulose microfiber product of the present invention derived from parenchymal cell material. These products are sometimes referred to herein as “exclusively parenchymal cell wall structures.” This is indicative of the fact that the majority source of the material comes from the cell structures of the plants that are parenchymal cells. As noted earlier, the HRC microfibers of the invention are not produced by mild treatment of the leaves, stems, etc. of the plants (which are not only parenchymal cell wall structures, but have much more substantial cell structures). This does not mean that any source of citrus or beet cells and fibers used in the practice of the present invention must be purified to provide only the parenchymal cells. The relative presence of the more substantive cells from leaves and stems will cause approximately that relative proportion of cell or fiber material to remain as less effective material or even material that is not converted to HRC, but will act more in the nature of fill for the improved HRC microfibers of the present invention. It may be desirable in some circumstances to allow significant portions of the more substantive cells and fibers to remain or even to blend the HRC (citrus or beet parenchyma based) product of the present invention with HRC fibers of the prior art to obtain particularly desired properties intermediate those of the present invention and those of the prior art. In the primary manufacturing process of the invention (that is, the process wherein the cells that have essentially only parenchymal cell walls are converted to HRC microfibers or particles according to the mild treatment process of the present invention), the more substantive cells and fibers may be present in weight proportions of up to fifty percent (50%). It is preferred that lower concentrations of the more substantive fibers are present so as to better obtain the benefit of the properties of the HRC fibers of the present invention, so that proportions of cells having exclusively parenchymal cell walls in the batch or flow stream entering the refining process stream constitute at least 50%, at least 60%, at least 70%, at least 80%, at least 90%, at least 95%, at least 97%, at least 98%, at least 99% or preferable about 100% of the fibrous or cellular material added to the refining flow stream. The final fiber product should also contain approximately like proportions of the HRC product of the present invention with regard to other HRC additives or fiber additives.

Among the unexpected properties and benefits of the HRC materials of the present invention derived from the mild refinement of cells and fiber from citrus and beet by-product are the fact of the HRC fibers, the stability of HRC fibers from parenchymal cells, the high water retention properties, the strength of the water retention properties of the fibers, the ability of the HRC fibers to retain water (moisture) even when heated, the ability of the HRC fibers to retain water (moisture) on storage, and the ability of the HRC fibers to retain moisture in food stuff without promoting degradation, deterioration or spoilage of the food as compared to food stuff with similar concentrations of moisture present in the product that is not bound by HRC fibers. The ability of the fiber materials of the present invention to retard moisture migration is also part of the benefit. This retarded water migration and water activity of water retained or absorbed by the fibers of the invention may be related to the previously discussed binding activity and binding strength of water by the fiber. As the moisture is retained away from other ingredients that are more subject to moisture-based deterioration, the materials of the invention provide significant benefits in this regard. These benefits can be particularly seen in food products (including baked goods such as breads, pastries, bars, loaves, cakes, cookies, pies, fillings, casseroles, protein salads (e.g., tuna salads, chicken salads), cereals, crackers, meats, processed dairy products, processed cheese, entrees and the like) that are stored as finished products either frozen, refrigerated, cooked, or at room temperature in packaging. The HRC fiber of the present invention may be provided as part of a package mix that can be used by the consumer, with the HRC fibers remaining in the final product to provide the benefits of the invention in the product finished (baked or cooked) by the consumer. The HRC fiber materials of the present invention provide other physical property modifying capabilities in the practice of the invention. For example, the fibers can provide thickening properties, assist in suspending or dispersing other materials within a composition, and the like. These properties are especially present in HRC fibers of the invention provided from sugar beets.

The percentage of fiber in the final product that is desirable to provide identifiable benefits is as low as 0.01% or 0.05% or 0.1% of the total dry weight of the final product. The HRC fiber product of the invention may be used as from 0.05 to 50% by weight of the dry weight of the product, 0.5 to 40%, 1 to 40%, 1 to 30%, 1 to 25%, 1 to 20%, 1 to 15%, 1 to 10%, and 2 to 20% by weight of the dry weight of the final product.

An unexpected property is for the finished dried product to have a viscosity in a 1% solution of 1000-300,000 centipoise at 0.5 rpms when measured using a Brookfield LVDV++ viscometer (Middleboro, Mass.). An additional unexpected property is for the end processed product to have similar rheology curves as other common hydrocolloids, such as xanthan gum. The expanded fiber products of the invention are highly effective and environmentally safe viscosity enhancers. In addition, they are quite useful in edible products, in addition to the functional benefits they add to edible products such as beverages, cheeses, baked goods, liquid and semi-liquid products (stews, soups, etc.).

Non-limiting examples of useful animal-derived proteins include, milk proteins that are isolated or derived from bovine milk; muscle tissue proteins that are isolated or derived from mammals, reptiles or amphibians; connective tissue proteins, egg proteins isolated or derived from eggs or components of eggs; and mixtures thereof. Non-limiting examples of useful milk proteins include caseins, such as sodium caseinate and calcium caseinate; and whey proteins, such as beta-lactoglobulin and alpha-lactalbumin. These milk proteins may be derived from whole milk, skim milk, nonfat dry milk solids, whey, whey protein concentrate, whey protein isolate, caseinates, and mixtures thereof. Non-limiting examples of useful connective tissue proteins include collagen, gelatin, elastin and mixtures thereof.

The active ingredient may be any drug for treating diseases or to promote general health, such as drugs in the class of 1) gastrointestinal agents; 2) antibiotics; 3) antiviral agents; 4) antifungal agents 5) antineoplastic agents; 6) analgesics; 7) tranquilizers; 8) narcotic antagonists; 9) antidepressants; 10) antihistamines; 1) antimigraine; 12) cardiovascular drugs; 13) calcium channel blockers; 14) appetite suppressant; 15) contraceptive agents; 16) corticosteroids; 17) local anaesthetics; 18) diuretics; 19) antihypertensive agents; 20) steroids; 21) prostaglandins; 22) anti-inflammatory drugs; 23) antithrombotic agents; 24) cardiac glycosides; 25) antiparkinsonism; 26) chemical dependency drugs; 27) acidic drugs such as salicylates (e.g., aspirin); and 28) peptides.

According to any of the above embodiments, the sterol compound may be an animal sterol or a plant sterol (also called phytosterol). Examples of animal sterol include cholesterol and all natural or synthesized, isomeric forms and derivatives thereof. Preferably, the sterol compound is selected from the group consisting of stigmasterol, campesterol, .beta.-sitosterol, chalinosterol, clionasterol, brassicasterol, .alpha.-spinasterol, dancosterol, desmosterol, poriferasterol, and all natural or synthesized, isomeric forms and derivatives thereof. More preferably, the sterol compound is a combination of stigmasterol, .beta.-sitosterol, and campesterol, collectively referred to herein as “sitosterol”.

Plant sterols for use herein can include any of various positional isomer and stereoisomeric forms, such as .alpha.-, .beta.-, or .gamma.-isomers. Typical phytosterols include .alpha.-sitosterol, .beta.-sitosterol, .gamma.-sitosterol, campesterol, stigmasterol, brassicasterol, spinosterol, taraxasterol, desmosterol, chalinosterol, poriferasterol, clionasterol, ergosterol, .DELTA.-5-avenosterol, .DELTA.-5-campesterol, clerosterol, .DELTA.-5-stigmasterol, .DELTA.-7,25-stigmadienol, .DELTA.-7-avenosterol, .DELTA.-7-.beta.-sitosterol, and .DELTA.-7-brassicasterol.

Suitable examples of phytosterol esters include .beta.-sitosterol laurate ester, .alpha.-sitosterol laurate ester, .gamma.-sitosterol laurate ester, campesterol myristearate ester, stigmasterol oleate ester, campesterol stearate ester, .beta.-sitosterol oleate ester, .beta.-sitosterol palmitate ester, .beta.-sitosterol linoleate ester, .alpha.-sitosterol oleate ester, .gamma.-sitosterol oleate ester, .beta.-sitosterol myristearate ester, .beta.-sitosterol ricinoleate ester, campesterol laurate ester, campesterol ricinoleate ester, campesterol oleate ester, campesterol linoleate ester, stigmasterol linoleate ester, stigmasterol laurate ester, stigmasterol caproate ester, .alpha.-sitosterol stearate ester, .gamma.-sitosterol stearate ester, .alpha.-sitosterol myristearate ester, .gamma.-sitosterol palmitate ester, campesterol ricinoleate ester, stigmasterol ricinoleate ester, campesterol ricinoleate ester, and stigmasterol stearate ester.

Useful phytostanols include .alpha.-, .beta.-, and .gamma.-sitostanol, campestanol, stigmastanol, spinostanol, taraxastanol, brassicastanol, desmostanol, chalinostanol, poriferastanol, clionastanol, and ergostanol.

Examples of phytostanol esters include .beta.-sitostanol laurate ester, campestanol myristearate ester, stigmastanol oleate ester, campestanol stearate ester, .beta.-sitostanol oleate ester, .beta.-sitostanol palmitate ester, .beta.-sitostanol linoleate ester, .beta.-sitostanol myristearate ester, .beta.-sitostanol ricinoleate ester, campestanol laurate ester, campestanol ricinoleate ester, campestanol oleate ester, campestanol linoleate ester, stigmastanol linoleate ester, stigmastanol laurate ester, stigmastanol caproate ester, stigmastanol stearate ester, .alpha.-sitostanol laurate ester, .gamma.-sitostanol laurate ester, .alpha.-sitostanol oleate ester, .gamma.-sitostanol oleate ester, .alpha.-sitostanol stearate ester, .gamma.-sitostanol stearate ester, .alpha.-sitostanol myristearate ester, .gamma.-sitostanol palmitate ester, campestanol ricinoleate ester, stigmastanol ricinoleate ester, campestanol ricinoleate ester, .beta.-sitostanol, .alpha.-sitostanol, .gamma.-sitostanol, campestanol, and stigmastanol.

Plant sterols can be derived from a variety of plant sources, including rice bran oil, corn fiber oil, corn germ oil, wheat germ oil, sunflower oil, safflower oil, oat oil, olive oil, cotton seed oil, soybean oil, peanut oil, canola oil, tea, sesame seed oil, grapeseed oil, rapeseed oil, linseed oil, tall oil and other oils obtained from wood pulp, and various other brassica crops. Although plant sterols are typically derived from plants, a plant sterol can also be synthetically prepared, e.g., it need not be derived from a plant source. Additionally, plant sterols can be prepared as mixtures of individual purified or synthesized plant sterol compounds or can be co-products resulting from purifications of other products (e.g., from plant sources). For example, a plant sterol can be obtained as a co-product of the manufacture of vitamin E and/or tocopherols from vegetable oil deodorizer distillate.

Other nutraceutical components and combinations of such ingredients that might be provided also include the non-limiting list of: Glycine max, Cicer arietinum, Cogent-db: Phaseolus mungo, Cyamompsis tetragonoloba of Azadirecta indica bark, Mucuna pruriens, Hordeum vulgare, Phyllanthus emblica, Terminalia Amaranthus hypochondriacus, Fagopyrum bellerica, T. chebula, esculantum, Gymnema sylvestre, Momordica Tribulus terrestris, Aconitum charantia, Syzgium cumini, Pterocarpus heterophyllum, Curcuma longa marsupium, Trigonella foenum-graecum, Syzygium cumini, Rotula Cinnamomum tamala, Withania somnifera, aquatica. Coccinia indica, Pueraria tuberosa, Boerhaavia difussa, and Piper longum, Basant Kusumakar Ras, Yasad Bhasam, Vang Amaranthus hypochondriacus, Fagopyrum Bhasam, Raj Jambu Beej, esculantum, Gymnema sylvestre, Momordica Guduchi, Sudh Shilajeet, charantia, Syzgium cumini, Pterocarpus Meshasringi, Shushavi Ghan, Neem Ghan, Methi Ghan, Cinnamomum tamala, Vijayasaar, Goshul, Asparagus racemosus, Boerhaavia difussa, Punamava, Aegle marmelos, Piper longum, Chlorophytum tuberosum, Elettaria cardamomum, Cyamompsis tetragonoloba, Swam Makshik Bhasam, Shilajeet Amaranthus hypochondriacus, Fagopyrum Shudh, Meshasringi, esculantum, Gymnema sylvestre, Momordica Shushavi Ghan, Guduchi, Arjun, Gokshus, Bhumlamlabi, Raj Jambu Patra, Cinnamomum tamala, Methini, Safed Chandan, Punarnava, Coccinia indica, Pueraria tuberosa, Satavar, Twak, Asparagus racemosus, Vijayasaar, Kramuka, Aguru, Elettaria cardamomuin and the like.

Plant sterols can be in any form, e.g., pastilles, prills, granules, or powders. Plant sterols can be obtained commercially from a number of sources, including Cargill, Incorporated (Minneapolis, Minn.), Cognis Nutrition and Health (La Grange, Ill.), Forbes Meditech (Vancouver, B.C. Canada), and ADM (Decatur, Ill.).

Amino acid sources that can be used to produce the nutritional compositions of the present invention may include or be derived from, but are not limited to, plant proteins, animal proteins, proteins from single cell organisms, free amino acids and mixtures thereof. Non-limiting examples of useful plant derived proteins include: seed proteins that are isolated or derived from legumes, such as soybeans, peanuts, peas and beans; cereal proteins isolated or derived from cereal grains, such as wheat, oats, rice, corn, barley and rye; and mixtures thereof. Non-limiting examples of useful seed proteins include materials selected from the group consisting of soy flour, soy protein concentrate, soy protein isolate, peanut flour and mixtures thereof. Non-limiting examples of useful cereal proteins include materials selected from the group consisting of wheat flour, wheat protein concentrate and mixtures thereof.

Fats that can be used to produce the nutritional compositions of the present invention may include or be derived from, but are not limited to, vegetable oils and fats, lauric oils and fats, milk fat, animal fats, marine oils, partially-digestible and nondigestible oils and fats, surface-active lipids and mixtures thereof. Useful vegetable oils and fats include, but are not limited to, triacylglycerols based on C18 unsaturated fatty acids such as oleic acids, linoleic acids, linolenic acids and mixtures thereof. Non-limiting examples of useful unhydrogenated, partially-hydrogenated and fully-hydrogenated vegetable oils include oils derived or isolated from soybeans, safflowers, olives, corn, cottonseeds, palm, peanuts, flaxseeds, sunflowers, rice bran, sesame, rapeseed, cocoa butter and mixtures thereof.

Useful lauric oils and fats include, but are not limited to, triacylglycerols based on lauric acid having 12 carbons. Non-limiting examples of useful lauric oils and fats include coconut oil, palm kernel oil, babassu oil and mixtures thereof.

Useful animal fats include, but not are not limited to, lard, beef tallow, egg lipids, intrinsic fat in muscle tissue and mixtures thereof.

Useful marine oils include, but are not limited to, triacylglycerols based on omega-3 polyunsaturated fatty acids such as docosahexanoic acid C22:6. Non-limiting examples of useful marine oils include menhaden oil, herring oil and mixtures thereof.

Useful partially-digestible and non-digestible oils and fats include, but are not limited to, polyol fatty acid polyesters, structured triglycerides, plant sterols and sterol esters, other non-digestible lipids such as esterified propoxylated glycerin (EPG), and mixtures thereof. Useful polyol fatty acid polyesters include, but are not limited to, sucrose polyesters, which are sold under the trade name of Olean® by the Procter & Gamble Company of Cincinnati, Ohio U.S.A. Non-limiting examples of useful structured triglycerides include caprenin, salatrim and mixtures thereof. Non-limiting examples of useful plant sterols and sterol esters include sitosterol, sitostanol, campesterol and mixtures thereof.

Partially-digestible and non-digestible oils and fats are particularly useful as they impart little or no calories to a food product and can impart a hypocholesterolemic capability to foods that incorporate said fats and oils. Examples of partially-digestible and non-digestible oils and fats that can provide a food with a hypocholesterolemic capability include, by way of example, sucrose polyesters which are sold under the trade name of Olean™ by the Procter & Gamble Company of Cincinnati, Ohio U.S.A.

Preferred partially digestible lipids are structured triglycerides comprising a combination of fluid chain fatty acids (i.e., short-chain saturated or unsaturated fatty acids) with long-chain, saturated fatty acids (chain lengths of C18-C24). An example of a partially digestible lipid is caprenin (Procter & Gamble Company, Cincinnati, Ohio, U.S.A.), which is a structured triglyceride comprised of octanoic acid (C8:0), decanoic acid (C10:0), and behenic acid (C22:0). Other examples are the reduced calorie triglycerides described in U.S. Pat. No. 5,419,925, which are triglycerides comprised of short chain-length, saturated fatty acids (C6:0-C10:0) and long chain-length, saturated fatty acids (C18:0-C24:0). Another example of partially digestible lipids are the salatrim family of low calorie fats developed by the Nabisco Foods Group (East Hanover, N.J.). The salatrim low-calorie fats are triglycerides comprised of short chain fatty acid residues (C2:0-C4:0) and long chain, saturated fatty acids (C16:0-C22:0. Salatrim is available under the brand name, Benefat™ from Cultor Food Science (Ardsley, N.Y.). Benefat™ is a specific component of the salatrim family, comprising acetic (C2:0), proprionic (C3:0), butyric (C4:0), and stearic (C18:0) acids.

Useful surface active lipids are amphiphilic molecules that may be purposefully added to food compositions for their functional performance or to enhance processability. Although these ingredients are adjunct ingredients, they will be detected as digestible fat by Applicants' analytical methods. Examples of surface active lipids are emulsifying agents, which are surface active lipids that stabilize oil-in-water or water-in-oil emulsions by orienting at the oil/water interface and reducing the interfacial tension; and foaming agents, which are surfactants that orient at the gas-water interface to stabilize foams. Surface active lipids may also be added as an inherent component of a food ingredient, such as the phospholipids found in soybean oil and egg yolks (e.g., lecithin). In addition, surface active lipids may be formed in the food as a result of the processing. For example, free fatty acids are formed in frying oils as a result of hydrolysis of the triglycerides and these fatty acids will be transferred to the fried food along with the oil that is transferred to the food.

Useful surface-active agents include, but are not limited to, free fatty acids, monoglycerides, diglycerides, phospholipids, sucrose esters, sorbitan esters, polyoxyethylene sorbitan esters, diacetyl tartaric acid esters, polyglycerol esters and mixtures thereof.

As used herein, the term “carbohydrate” refers to the total amount of sugar alcohols, monosaccharides, disaccharides, oligosaccharides, digestible, partially digestible and non-digestible polysaccharides; and lignin or lignin like materials that are present in the embodiments of the present invention. Carbohydrates that can be incorporated into the present invention may include, but are not limited to, monosaccharides, disaccharides, oligosaccharides, polysaccharides, sugar alcohols and mixtures thereof. Non-limiting examples of useful monosaccharides include: tetroses such as erythrose; pentoses such as arabinose, xylose, and ribose; and hexoses such as glucose (dextrose), fructose, galactose, mannose, sorbose and tagatose.

Non-limiting examples of useful disaccharides include: sucrose, maltose, lactose and cellobiose. Non-limiting examples of useful oligosaccharides include: fructooligosaccharide; maltotriose; raffinose; stachyose; and corn syrup solids (maltose oligomers with n=4-10). Useful polysaccharides include, but are not limited to, digestible polysaccharides and non-digestible polysaccharides. Non-limiting examples of useful digestible polysaccharides include starches that are isolated or derived from cereal grains, legumes, tubers and roots; maltodextrins obtained by the partial hydrolysis of starch; glycogen and mixtures thereof. Non-limiting examples of useful starches include flours from cereals, legumes, tubers and roots; native, unmodified starches, pre-gelatinized starches, chemically modified starches, high amylose starches, waxy starches; and mixtures thereof. Useful non-digestible polysaccharides may be water-soluble or water-insoluble. Non-limiting examples of useful water-soluble or predominately water-soluble, non-digestible polysaccharides include: oat bran; barley bran; psyllium; pentosans; plant extracts such as pectins, inulin, and beta-glucan soluble fiber; seed galactomannans such as guar gum, and locust bean gum; plant exudates such as gum arabic, gum tragacanth, and gum karaya; seaweed extracts such as agar, carrageenans, alginates, and furcellaran; cellulose derivatives such as carboxymethylcellulose, hydroxypropyl methylcellulose and methylcellulose; microbial gums such as xanthan gum and gellan gum; hemicellulose; polydextrose; and mixtures thereof. Non-limiting examples of water-insoluble, and predominately water-insoluble, non-digestible polysaccharides include cellulose, microcrystalline cellulose, brans, resistant starch, and mixtures thereof.

Useful sugar alcohols include, but are not limited to, glycerol, sorbitol, xylitol, mannitol, maltitol, propylene glycol, erythritol and mixtures thereof.

Additional agents may include at least the following natural and synthetically prepared flavoring agents, non-caloric sweeteners, bracers, flavanols, natural and synthetically prepared colors, preservatives, acidulants, and food stability anti-oxidants. A flavoring agent is recommended for the embodiments of this invention in order to further enhance their taste. As used herein the term “flavoring agents” encompass seasonings and spices. Flavors may be added to the initial formulation, or be added topically after the product is produced. Any natural or synthetic flavor agent can be used in the present invention. Fruit flavors, natural botanical flavors, and mixtures thereof can be used as the flavoring agent. Particularly preferred savory flavors are grain based, spice based, and buttery type flavors. Besides these flavors, a variety of sweet flavors such as chocolate, praline, caramel and other fruit flavors can be used such as apple flavors, citrus flavors, grape flavors, raspberry flavors, cranberry flavors, cherry flavors and the like. These fruit flavors can be derived from natural sources such as fruit juices and flavor oils, or else be synthetically prepared. Preferred natural flavors are aloe vera, ginseng, ginkgo, hawthorn, hibiscus, rose hips, chamomile, peppermint, fennel, ginger, licorice, lotus seed, schizandra, saw palmetto, sarsaparilla, safflower, St. John's Wort, curcuma, cardamom, nutmeg, cassia bark, buchu, cinnamon, jasmine, haw, chrysanthemum, water chestnut, sugar cane, lychee, bamboo shoots and the like. Typically the flavoring agents are conventionally available as concentrates or extracts or in the form of synthetically produced flavoring esters, alcohols, aldehydes, terpenes, sesquiterpenes, and the like. When used in any embodiment, flavoring agents are added in effective levels.

Various recipes for snacks, chips, matzos and other unleavened food products are described in U.S. Pat. Nos. 6,479,090, which are herein incorporated by reference for their recipes, as are all references cited herein, including the applications ans patents in the priority claim.

Cohesive, machinable doughs which can be sheeted, stretched, and cut into pieces may be produced at room temperature when the doughs possess a high content of wheat or other gluten-containing flour. The baking of conventional wheat-based doughs into crackers provides a lamellar structure with generally uniform small cells and a tender, mealy, leavened texture. Upon mastication, the conventional crackers generally disperse more rapidly than does a chip. They do not provide a crunchy texture and a sensation of breaking into pieces with low molar compaction before dispersion as does a chip. Additionally, crackers are generally dockered to prevent pillowing and to provide a generally flat bottom surface and a blistered top surface. Oyster or soup crackers and snack crackers which have a pillowed appearance may be produced from wheat-based doughs by the elimination of dockering holes. However, these products still possess a leavened, tender, mealy texture and a cracker appearance, rather than a crisp, crunchy chip-like texture and chip-like appearance.

One general description for technology described herein includes as an edible food product comprising at least a) 0.05%-5% by total weight highly refined cellulose product defined by a fiber material that has a total dietary fiber (TDF) content greater than 30% as measured by AOAC 991.43 and a water holding capacity greater than five parts water per part fiber as measured by AACC 56-30 and comprises less than 90% soluble fiber, and at least b) 0.05% by total weight of a nutraceutical. Alternatively, the edible food product may comprise at least a) 0.05%-5% by total weight highly refined cellulose (HRC) having a lignin concentration of at least 1% by weight and a water retention capacity of at least about 20 g H₂O/g dry HRC, and/or the HRC has an oil retention capacity of at least about 10 g/g dry HRC, and/or the HRC is dehydrated or a dispersion, and/or the HRC has a Langmuir surface area of at least about 7 m²/g, and/or the HRC has an average pore diameter of at least about 5 angstroms. The edible food product may have the nutraceutical provide an expectation of a health benefit selected from the group consisting of:
a. Antioxidation;
b. Cancer prevention;
c. Arterial health improvement;
d. Cholesterol lowering;
e. Reduced blood pressure; and
f. Skin and wrinkle treatment.
g. Prolonging and/or delaying release of a nutrient, e.g., sugar, into the bloodstream.

The edible food product may have the nutrceutical is selected from the classes consisting of: 1) gastrointestinal agents; 2) antibiotics; 3) antiviral agents; 4) antifungal agents 5) antineoplastic agents; 6) analgesics; 7) tranquilizers; 8) narcotic antagonists; 9) antidepressants; 10) antihistamines; 11) antimigraine; 12) cardiovascular drugs; 13) calcium channel blockers; 14) appetite suppressant; 15) contraceptive agents; 16) corticosteroids; 17) local anaesthetics; 18) diuretics; 19) antihypertensive agents; 20) steroids; 21) prostaglandins; 22) anti-inflammatory drugs; 23) antithrombotic agents; 24) cardiac glycosides; 25) antiparkinsonism drugs; 26) chemical dependency drugs; and 27) peptides, 28) energy supplements.

A method of providing a mass an edible food product is described that comprises providing:
a) 0.05%-5% by total weight highly refined cellulose product defined by a fiber material that has a total dietary fiber (TDF) content greater than 30% as measured by AOAC 991.43 and a water holding capacity greater than five parts water per part fiber as measured by AACC 56-30 and comprises less than 90% soluble fiber;
   blending or mixing a) with b) a nutraceutical to form an edible mass.
   The method above may also provide the mass an edible food product by providing: a) 0.05%-5% by total weight highly refined cellulose product (HRC) having a lignin concentration of at least 1% by weight and a water retention capacity of at least about 20 g H.sub.2O/g dry HRC, and blending or mixing a) with b) a nutriceutical to form an edible mass. The method may continue with the edible mass added to gluten products to form a cookable mass and the cookable mass is cooked to provide a consumable product.

A further method may be practiced of improving the health or well-being of an animal comprising providing the food product of claim 1 to an animal and the animal ingesting the food product.

### PREPARATION EXAMPLES OF HIGHLY REFINED CELLULOSE MATERIALS BY PREFERRED PROCESSES

### Example 1

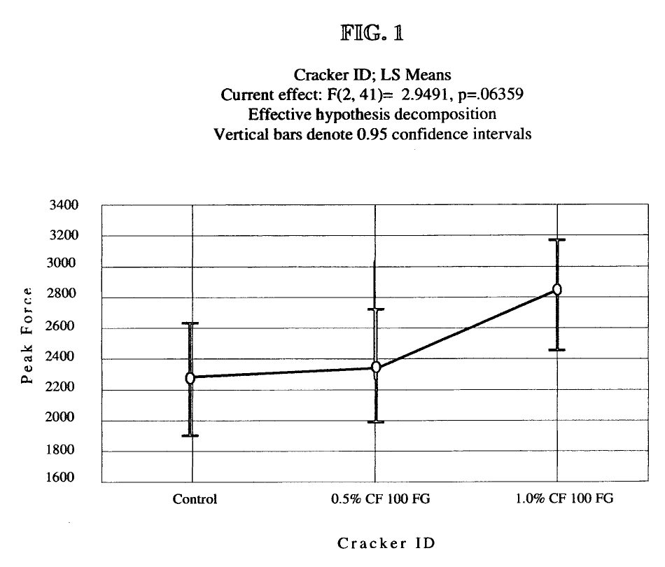

Dried beet pulp shreds were obtained from a local feed store. The beet pulp was then ground to a powder using a disk mill or refiner. One particularly useful plate refiner is manufactured by Sprout Waldron of Muncy, Pa. and is Model 12-ICP. This plate refiner has a 60 horsepower motor that operates at 1775 rpm. After the dry materials were ground, they were soaked in hot water at 100° C. for 5 minutes at 5% solids, where the materials started to absorb moisture. The soaked materials were then washed with water in a screen cart to remove any unwanted particulate or soluble materials. After soaking, the materials were diluted to 3% solids and bleached in a 150 gallon (555 liter) tank with agitation. The bleaching conditions were 15% hydrogen peroxide (based on dry matter weight), a pH of 11.5, and a temperature of 80° C. for one hour. After bleaching, the material was then washed in a screen cart. After bleaching, the materials were then refined again at 3% solids using the same refiner in the first step, which was followed by further reducing particle sizes in an IKA Dispax Reactor, Model DR 3-6A (Wilmington, N.C.). The dispersed materials were then homogenized three times at 8000 psi (approximately 5×10⁵ sec⁻¹ shear rate) using a APV Gaulin high pressure homogenizer, Model MC(P)-45 (Wilmington, Mass.). The homogenized materials were then dried at 120° F. in a Harvest Saver Dehydrator made by Commercial Dehydrator Systems (Eugene, Oreg.). The dried materials were then ground in a Fitzmill, Model D6 (Elmhurst, Ill.), with a 0.050 inch (0.12 cm) round 22 gauge 316 mesh stainless steel screen. After grinding, the ground materials were then rehydrated at 1% solids using a standard kitchen household blender on high speed for three minutes. Viscosity was then measured using a Brookfield LVDV++viscometer (Middleboro, Mass.) with cylindrical spindles. Keltrol xanthan and propylene glycol alginate (PGA) were obtained from CP Kelco. 1% solutions were made by mixing the materials in a blender for 3 minutes. Rheology was determined using the same Brookfield viscometer. The results are shown in FIG. 1. This data shows that the fibers of the invention are capable of providing a viscosity of at least 23,000 at a concentration of 1% fibers derived from sugar beets at 1 rpm at 20° C. It is within the skill of the artisan using the teachings of this invention to provide viscosities of greater than 24,000 and greater than 25,000 at these concentrations and conditions to produce the parenchymal cell based highly refined cellulose fibers of the invention. This is evidence by FIG. 1.

FIG. 1: Comparison of rheology curves for Fiberstar's processed beet pulp versus xanthan and PGA (propylene glycol alginate).

### Citrus Examples 2-6

### Example 2

Frozen washed orange pulp cells were obtained from Vita Pakt (Covina, Calif.). Hot water was added to the frozen pulp to thaw the pulp. After thawing, the materials were dewatered on a screen to remove any excess water and bring the solids content to 5%. The thawed and screened materials were refined using a Sprout Waldron disk mill (Muncy, Pa.), Model 12-ICP. The refined materials were then dispersed at 5% solids at 50,000 sec⁻¹ shear rate using an IKA Dispax™ Reactor, Model DR 3-6A (Wilmington, N.C.). Viscosity was then measured using a Brookfield LVDV++ viscometer (Middleboro, Mass.) with cylindrical spindles.

### Example 3

Frozen washed orange pulp cells were obtained from Vita Pakt™ (Covina, Calif.). Hot water was added to the frozen pulp to thaw the pulp. After thawing, the materials were dewatered on a screen to remove any excess water and produce a pulp with a 5% solids content. The thawed and screened materials were refined at 5% solids using a Sprout Waldron disk mill (Muncy, Pa.), Model 12-ICP. The refined materials were then dispersed using an IKA Dispax™ Reactor, Model DR 3-6A (Wilmington, N.C.) at 5% solids. The dispersed materials were then homogenized one time at 8000 psi using an APV Gaulin high pressure homogenizer, Model MC(P)-45 (Wilmington, Mass.) at 5% solids. Viscosity was then measured using a Brookfield LVDV++viscometer (Middleboro, Mass.) with cylindrical spindles.

### Example 4

Frozen washed orange pulp cells were obtained from Vita Pakt™ (Covina, Calif.). Hot water was added to the frozen pulp to thaw the pulp. After thawing, the materials were dewatered on a screen to remove any excess water and produce a pulp with a 5% solids content. The thawed and screened materials were refined at 5% solids using a Sprout Waldron disk mill (Muncy, Pa.), Model 12-ICP. The refined materials were then dispersed using an IKA Dispax™ Reactor, Model DR 3-6A (Wilmington, N.C.) at 5% solids. The dispersed materials were then homogenized one time at 8000 psi (approximately 5×10⁵ sec⁻¹ shear rate) using an APV Gaulin high pressure homogenizer, Model MC(P)-45 (Wilmington, Mass.) at 5% solids. The homogenized materials were then dried at 70° F. (21° C.) in a Harvest Saver™ Dehydrator made by Commercial Dehydrator Systems (Eugene, Oreg.). The dried materials were then ground in a Fitzmill, Model D6 (Elmhurst, Ill.), with a 0.050 inch round 22 gauge 316 stainless steel screen. After grinding, the ground materials were then rehydrated at 1% solids using a standard kitchen household blender on high speed for three minutes. Viscosity was then measured using a Brookfield LVDV++viscometer (Middleboro, Mass.) with cylindrical spindles.

### Example 5

Frozen washed orange pulp cells were obtained from Vita Pakt™ (Covina, Calif.). Hot water was added to the frozen pulp to thaw the pulp. After thawing, the materials were dewatered on a screen to remove any excess water and produce a pulp with a 5% solids content. These materials were then put in a blender on high speed for 3 minutes (approximately 30,000 to 40,000 sec⁻¹ shear rate) and the viscosity was then measured using a Brookfield LVDV++ viscometer (Middleboro, Mass.) with cylindrical spindles.

### Example 6

Frozen washed orange pulp cells were obtained from Vita Pakt™ (Covina, Calif.). Hot water was added to the frozen pulp to thaw the pulp. After thawing, the materials were dewatered on a screen to remove any excess water and produce a pulp with a 5% solids content. The thawed materials were then dried at 70° F. (21° C.) in a Harvest Saver Dehydrator made by Commercial Dehydrator™ Systems (Eugene, Oreg.). The dried materials were then ground in a Fitzmill, Model D6 (Elmhurst, Ill.), with a 0.050 inch (0.12 cm) round 22 gauge 316 mesh stainless steel screen. After grinding, the ground materials were then rehydrated at 1% solids using a standard kitchen household blender on high speed for three minutes (approximately 30,000 to 40,000 sec⁻¹ shear rate). Viscosity was then measured using a Brookfield LVDV++ viscometer (Middleboro, Mass.) with cylindrical spindles.

Table showing viscosities of citrus pulp cells after various treatment
conditions,.

| | Viscosity (cP) | | |
|---|---|---|---|
| Example # | Solids % | 0.5 rpm | 10 rpm |
| 2) | 1% | 15207 | 1428 |
| 3) | 1% | 15477 | 1966.5 |
| 4) | 1% | 8728 | 587.5 |
| 5) | 1% | 15117 | 1608 |
| 6) | 1% | 10275 | 999 |

### Example 7

### Dry Product Rehydration Using Production Size Equipment

Quadro™ (Milburn, N.J.) [rehydrated dry orange pulp product at 3% solids and ran the mixture through their Model Z3 emulsifier various times. As shown in the following table, one pass through their emulsifier is more effective than rehydrating by shearing 3.5 minutes in a blender. With this style machine, our product is fed into the disperser feeder, where it drops into the water stream, gets hydrated, and goes directly to the ingredient mix without the need for an allocated dispersing tank and can be sized to rehydrate on a large production scale.

Table showing viscosities of citrus pulp cells after various treatment
conditions,.

| Shearing | Viscosity (cP), 3% | | | | |
|---|---|---|---|---|---|
| Method | 0.5 rpm | 10 rpm | 60 rpm | 100 rpm | 200 rpm |
| Disp, 1 pass | 25,375 | 1,923 | 405 | 260.1 | 138.5 |
| Disp, 2 passes | 36,172 | 1,668 | 473 | 335 | 191 |
| Disp, 3 passes | 35,512 | 1776 | 525 | 340 | 185.1 |
| Blender, 3.5 min | 17,396 | 1617 | 321.9 | 218.4 | 138 |

### Example 8

Dried citrus peel and/or beet fiber products commonly sold today for a fiber source can also be processed and produce a functional product. A dry ground citrus peel product was obtained from Vita Pakt™ (Covina, Calif.). The dry ground citrus peel was then dispersed at 3% solids using an IKA Dispax™ Reactor, Model DR 3-6A (Wilmington, N.C.) at 5% solids. The dispersed materials were then homogenized one time at 8000 psi using an APV Gaulin high pressure homogenizer, Model MC(P)-45 (Wilmington, Mass.). Viscosity was then measured using a Brookfield LVDV++ viscometer (Middleboro, Mass.) with cylindrical spindles.

| | Viscosity (cP), 3% | | | | |
|---|---|---|---|---|---|
| Method | 0.5 rpm | 10 rpm | 60 rpm | 100 rpm | 200 rpm |
| Dry product in | <10 | <10 cP | <10 cP | <10 cP | <10 Cp |
| water | | | | | |
| Dry product after | 1666 | 213 | 65 | 44 | 29 |
| shearing | | | | | |

### Example 9

### Fluid Bed Drying

Fluid bed drying trials were performed using a Carrier Vibrating Equipment (Louisville, Ky.) a one square (foot vibrating fluid bed dryer. Dry products were attained having functionality that was near identical to the wet feed materials. The drying tests were conducted using 100-140° F. (38-60° C.) outlet air temperatures, 400° F. (205° C.) air inlet temperatures, and residence times in the dryer were around 5-25 minutes. All materials that underwent drying were dried to less than 15% moisture. All viscosities were measured at 1% using a Brookfield LVDV++ viscometer (Middleboro, Mass.) with cylindrical spindles. Prior to drying, the wet materials need to be back mixed (that is wetter materials are added to the drier materials to facilitate drying of the wetter materials) with the dry materials (backmix ratio was 2 parts dry to 1 part wet) and a total of 6 lbs (2.6 kg) of wet feed was put in the batch style dryer. The results from the testing are shown below:

| Drying | Moisture | Viscosity (cP), 1% | | | | |
|---|---|---|---|---|---|---|
| Conditions | % | 0.5 rpm | 10 rpm | 60 rpm | 100 rpm | 200 rpm |
| Feed | 39.5 | 5020 | 577 | 220 | 155 | 87 |
| material | | | | | | |
| 400 F. | 12.2 | 5929 | 515 | 178 | 145 | 80 |
| drying air | | | | | | |

### Example 10

### Flash Drying

Pilot scale Flash drying trials were performed using a Carrier Vibrating Equipment (Louisville, Ky.) Tornesh dryer. Prior to drying, the wet materials (dispersed orange pulp, as from Example 2) were to be back mixed with the dry materials, again orange pulp from Example 2 (backmix ratio was 2 parts dry to 1 part wet) and a total of 30 lbs (13 kg) of 50% moisture wet feed was put in the dryer. Dry products were attained having functionality that was similar to the wet feed materials. The drying tests were conducted using 200° F. (94° C.) outlet air temperatures and residence times in the dryer were around 1-3 minutes. The dried materials were rehydrated using a blender on high speed for 3 minutes and all viscosities were measured at 1% using a Brookfield LVDV++ viscometer (Middleboro, Mass.) with cylindrical spindles. The results from the testing are shown below:

Table showing results of flash drying trials.

| Drying | Moisture | Viscosity (cP), 1% | | | | |
|---|---|---|---|---|---|---|
| Conditions | % | 0.5 rpm | 10 rpm | 60 rpm | 100 rpm | 200 rpm |
| Feed | 39.5 | 5020 | 577 | 220 | 155 | 87 |
| material | | | | | | |
| Flash dried | 13.9 | 4232 | 368 | 134 | 88 | 53 |
| feed | | | | | | |
| materials | | | | | | |
| (400 F. air) | | | | | | |

### PRODUCT USE EXAMPLES OF HIGHLY REFINED CELLULOSE MATERIALS

### Example 11

A reduced fat shortening was made by adding Citri-Fi™ 200 FG citrus fiber coprocessed with guar gum from Fiberstar, Inc., water, and vegetable shortening. The water level used was both three and six times the weight of Citri-Fi™ and one half of the shortening was replaced with citrus fiber and water combination. Test 1 contained 100% vegetable shortening. Test 2 contained shortening at 50% and the balance being Citri-Fi™ 200 FG (citrus fiber, guar gum) and water at 6 times the weight of fiber. Test 3 contained shortening at 50% and the balance being Citri-Fi™ 200 FG (citrus fiber, guar gum) and water at 3 times the weight of fiber. All tests were conducted at 75 F with five replicates. The spreadability of the spreads was evaluated using a texture analyzer available from Texture Technologies with a spreadibility rig (TA-425 TTC) to measure the cohesive and adhesive forces of the spreads. The test results are shown in Table 1.

TABLE 1
Cohesive and adhesive forces as measured by a texture analyzer of a 100%
vegetable shortening compared to 50% shortening and balance being
Citri-Fi ™ 200 FG (citrus fiber, guar gum) and water at 6 times
the fiber weight (Test 2) and 3 times the fiber weight (Test 3).

| | Cohesive force | Adhesive force |
|---|---|---|
| Test Number | (g/mm) | (g/mm) |
| Test 1 | 1555.89^{A,b} | −1137.96^{a} |
| Test 2 | 1353.1^{a} | −1061.1^{a} |
| Test 3 | 1736.2^{b} | −1428.49^{b} |

A & B: Denote groupings that are not statistically different from each other.

The spreadability results from Table 1 show that a 50% shortening spread can be made with very similar spreadability to a 100% shortening product. And the adhesive and cohesive forces can be adjusted depending on the amount of water used along with the citrus fiber. In this example, if water is used at three times the weight of the citrus fiber, guar gum, then the spread had more adhesive and cohesive forces and was more firm. Whereas if water is used at six times the weight of the citrus fiber, guar gum, then the spread had less cohesive and adhesive forces and was slightly less firm.

### Example 12

Another test was conducted by adding Citri-Fi™ 200 FG (citrus fiber, guar gum), water, to a low trans roll-in, commonly used in the production of Danish, available from Bunge. Once again various water levels were used to evaluate the differences of water levels but another variable of the amount of roll-in replaced was also evaluated. The amount of roll-in replaced was 33% and 50%. Once again the cohesive and adhesive forces were measured using a texture analyzer. Test 4 contained the low trans roll in at 100%. Test 5 contained the low trans roll in at 66% and the remaining being fiber and water at six times its weight. Test 6 contained the low trans roll at 50% and the remaining being fiber and water at 3 times the weight of fiber. Test 7 contained low trans roll in 50% and the remaining being fiber and water at 6 times the weight of fiber. The test results are shown in Table 2.

TABLE 2
Cohesive and adhesive forces as measured by a texture analyzer of
control low trans roll in and reduced fat low trans roll-in spread. Test 4
contained the low trans roll in at 100%. Test 5 contained the low trans
roll in at 66% and the remaining being fiber and water at six times its
weight. Test 6 contained the low trans roll at 50% and the remaining
being fiber and water at 3 times the weight of fiber. Test 7 contained
low trans roll in 50% and the remaining being fiber and water at 6 times
the weight of fiber.

| | | Adhesive force |
|---|---|---|
| Test Number | Cohesive force (g/mm) | (g/mm) |
| Test 4 | 1295.88^{a} | −1092.29^{a} |
| Test 5 | 1357.79^{a} | −1120.43^{a} |
| Test 6 | 2135.99^{b} | −1899.33^{b} |
| Test 7 | 1803.58^{c} | −1687.1^{c} |

Superscript groupings with common letters denote groupings that are not statistically different from each other.

The results from this testing suggests that with the low trans roll in product, using water at six times the weight of Citri-Fi™ 200 FG (citrus fiber, guar gum) was effective at making a product with similar cohesive and adhesive forces when doing a 33% roll-in replacement, however, at the higher replacement level of 50%, the roll-in was considerably more firm when water was used at either 6 or 3 times the weight of fiber. These results would indicate that to attain a similar spreadibility for this product, a higher water level could be used.

### Example 13

Another round of tests was conducted using a margarine roll in commonly used in the production of Danish. This time a straight water level of six times the weight of Citri-Fi™ 200 FG (citrus fiber, guar gum) was used and two levels of roll-in replacement were evaluated, namely, 50% and 33% replacement. The cohesive and adhesive forces were measured using the same texture analyzer and rigging as in examples one and two. Test 8 contained 100% margarine roll-in. Test 9 contained margarine roll-in at 66% and the balance being Citri-Fi™ 200 FG (citrus fiber, guar gum) and water at 6 times the weight of fiber. Test 10 contained margarine roll-in at 50% and the balance being Citri-Fim 200 FG (citrus fiber, guar gum) and water at 6 times the weight of fiber. The test results are shown in Table 3.

TABLE 3
Cohesive and adhesive forces as measured by a texture analyzer of control
margarine roll in and reduced fat margarine roll-in spread. Test 8
contained 100% margarine roll-in. Test 9 contained margarine roll-in
at 66% and the balance being Citri-Fi ™ 200 FG (citrus fiber,
guar gum) and water at 6 times the weight of fiber. Test 10 contained
margarine roll-in at 50% and the balance being Citri-Fi ™ 200
FG (citrus fiber, guar gum) and water at 6 times the weight of fiber.

| | Cohesive force | Adhesive force |
|---|---|---|
| Test Number | (g/mm) | (g/mm) |
| Test 8 | 1433.12^{a} | −1184.75^{a} |
| Test 9 | 998.48^{b} | −865.97^{b} |
| Test 10 | 1084.98^{b} | −986.34^{b} |

The test results shown in Table 3 suggest that with this margarine roll-in, a water level of 6 times the weight of fiber may be higher than what is needed to make a reduced fat roll-in with equivalent spreadability compared the full fat control.

### Example 14

In Example 11 and in Example 12 we showed that the by adding water at three times the weight of the Citri-Fi™ 200 FG (citrus fiber, guar gum) can make the reduced fat spread more thick compared to the control spread. However, an alternative way to make a more cohesive and adhesive texture is to start with a fat that has a harder texture and to add the 6 times water and fiber to this starting mixture. In this example, a Swede Gold shortening was used along with Citri-Fi™ 200 FG (citrus fiber, guar gum) and water at 6 times the fiber weight. The texture of this combination was compared to the control roll-in as shown in Test 8. The spreadability of the spreads was evaluated using a texture analyzer available from Texture Technologies with a spreadibility rig (TA-425 TTC) to measure the cohesive and adhesive forces of the spreads.

TABLE 4
Cohesive and adhesive forces as measured by a texture analyzer of control
margarine roll in and reduced fat margarine roll-in spread. Test 8
contained 100% margarine roll-in. Test 11 contained a hard fat roll-in
that was reduced by 50% with Citri-Fi ™ 200 FG (citrus fiber,
guar gum) and water at 6 times the fiber weight.

| | Cohesive force | Adhesive force |
|---|---|---|
| Test Number | (g/mm) | (g/mm) |
| Test 8 | 1433.12^{a} | −1184.75^{a} |
| Test 11 | 2159.61^{b} | −1731.63^{b} |

### Example 15

A control Danish made with 100% margarine roll-in was compared to a Danish made with a reduced fat roll-in that was prepared and compared to a 66% roll-in and balance being Citri-Fi™ 200 FG (citrus fiber and guar gum). The water level used was six times the weight of the fiber. Roll in is typically used in a Danish to produce the flaky and layered texture that is desired for a Danish or croissant. Thus, the test with the reduced fat roll in to see if the layered texture and flakyiness could be maintained when the roll-in had a percentage replaced with Citri-Fi™ 200 FG (citrus fiber and guar gum) and water. The following formula was used for the control and reduced fat Danish.

TABLE 5
Formula used in the production of a control and reduced fat roll-in Danish.

| | Control | 50% Reduced |
|---|---|---|
| Item Name | (lbs) | Shortening |
| Danish Base | 100.00 | 100.00 |
| Eggs, Whole | 8.04 | 8.04 |
| Water | 34.29 | 34.29 |
| Yeast | 3.52 | 3.52 |
| Roll In | 8.71 | 5.81 |
| Water | 0.00 | 2.49 |
| Citri-Fi ™ 200 FG | 0.00 | 0.42 |

After baking, the eating qualities in terms of taste, texture, flakiness, of both the control and reduced fat Danish were noted to be near identical to each other, which suggests that the Citri-Fi™ 200 FG (citrus fiber and guar gum) and additional water in the reduced fat roll-in can maintain the integrity of the full fat roll-in to provide a layered and flaky texture.

### Example 16

### Reduced Fat Cake

Citri-Fi™ 100 citrus fiber from Fiberstar, Inc. was used in testing a 50% reduced fat shortening cake formula. The amount of Citri-Fi™ 100 citrus fiber used was 0.125 times the weight of shortening removed from the formula and the amount of water was 7 times the weight of Citri-Fi™ 100 citrus fiber. The nutritional analysis for the control and test cake formula was generated using Genesis software from Esha Research (Salem, Oreg.). The cake was made according to the formula shown in Table 1:

| | Control | Reduced |
|---|---|---|
| Ingredient | formula | shortening |
| Step 1 | | |
| granulated sugar | 110.1 | 110.1 |
| cake shortening | 52.9 | 26.5 |
| Citri-Fi ™ 100 | 0 | 5.3 |
| water | 0 | 15.9 |
| Step 2 | | |
| cake flour | 100 | 100 |
| non fat dry milk | 10.1 | 10.1 |
| baking powder | 7.6 | 7.6 |
| soda | 0.7 | 0.7 |
| salt | 3.7 | 3.7 |
| pre-gel wheat | 4.9 | 4.9 |
| starch | | |
| Step 3 | | |
| water | 70 | 70 |
| Step 4 | | |
| whole eggs | 89.9 | 89.9 |
| vanilla flavor | 2.5 | 2.5 |
| water | 19.9 | 19.9 |
| TOTAL | 472.3 | 467.1 |

Here is the mixing and baking procedure for the cakes.

1. Combine fiber, water, shortening, and sugar in the mixing bowl, and mix on low for 2 minutes with a flat paddle.
2. Add: cake flour, sugar, dried milk, baking powder, baking soda, salt, and pre gelatinized wheat starch.
3. Gradually add the water in step 3, and mix on low for 4 minutes. Scrape the bowl.
4. Combine eggs, vanilla flavor, and water then add them in two parts.
5. Mix for 2 minutes after each half addition from step 4 and scrape after each addition.
6. Make sure that the mix is properly combined, and if it's not then mix it a few more minutes.
7. Scale 580 grams of batter in each pan.
8. Bake at 360 degrees Fahrenheit for 29 minutes.

The following table shows the nutritional information for the control and test cakes, which shows the reduced trans and saturated fat levels.

Cake Nutritional information

| Nutrient | Control | Test |
|---|---|---|
| Gram weight, g | 100 | 100 |
| Calories, kcal | 308 | 273 |
| Calories from Fat | 123 | 75.6 |
| Protein, g | 4.64 | 4.99 |
| Carbohydrates, g | 42.9 | 46.3 |
| Dietary Fiber, g | 0.57 | 1.5 |
| Total Sugars, g | 25.8 | 27.7 |
| Total Fat, g | 13.6 | 8.4 |
| Saturated Fat, g | 3.18 | 1.98 |
| Trans Fatty Acid, g | 3.4 | 1.79 |

This table shows the physical properties of the cakes in terms of the cakes height and volume, which shows the test cake with reduced fat and Citri-Fi™ 100 citrus fiber had increased height and volume.

| | height | volume |
|---|---|---|
| Cake | (mm) | (mm\hat{ }3) |
| Control | 38.2 | 1386 |
| Test | 41.6 | 1510 |

Because shortening has a softening effect in bakery products and allows them to stay fresher longer, these results show that Citri-Fi™ citrus fiber can be used to replace fat, shortening, and oil and maintain a product with similar eating qualities to the control.

### Example 17

### Reduced Fat Bread

Bread was made according to the formula shown in the following table where 100% of the shortening was placed in the formula. Citri-Fi™ 200 citrus fiber and guar gum was used in this test.

| | Control | 50% fat |
|---|---|---|
| Item Name | Formula | Formula |
| Flour | 1000 | 1000 |
| Water, municipal | 620 | 620 |
| granulated sugar | 90 | 90 |
| extra water | 0 | 90 |
| compressed yeast | 70 | 70 |
| Shortening | 60 | 0 |
| wheat bran | 30 | 30 |
| Salt | 22 | 22 |
| Citri-Fi ™ 200 citrus fiber | 0 | 15 |
| and guar gum | | |
| Calcium proprionate | 4 | 4 |
| Sodium stearyol lactylate | 2 | 2 |

Here is the nutritional information for the bread.

| Nutrient | Control | Test |
|---|---|---|
| Gram weight, | 100 | 100 |
| grams | | |
| Calories, kcal | 270 | 260 |
| Protein, g | 9 | 9 |
| Carbohydrates, g | 55 | 55 |
| Dietary Fiber, g | 2 | 2 |
| Total Sugars, g | 6 | 6 |
| Total Fat, g | 2 | 1 |
| Saturated Fat, g | 0 | 0 |
| Trans Fatty Acid, g | 0.5 | 0 |

The loaf volume, eating characteristics, and grain for both breads came out looking nearly identical to each other. To the touch the 100% less shortening bread was significantly softer than the control.

### Example 18

### Reduced Fat Sweet Rolls

Citri-Fi™ 100 citrus fiber was used to make a 50% reduced fat shortening in a sweet roll according the formula in the following table.

| | | 50% reduced |
|---|---|---|
| Item Name | Control | Shortening |
| Flour, all purpose | 500 | 500 |
| Flour, pastry | 500 | 500 |
| Shortening | 240 | 120 |
| Eggs, whole | 240 | 240 |
| Milk, whole, dry pwd | 60 | 60 |
| Water, municipal | 450 | 450 |
| Yeast, compressed | 60 | 60 |
| Salt, table | 17.5 | 17.5 |
| Sugar, granulated | 240 | 240 |
| Citri-Fi ™ 100 citrus | 0 | 34.8 |
| fiber | | |
| Water, municipal | 0 | 139 |

Here is the nutritional information for the sweet roll formula, which was generated using Genesis software.

Sweet Roll Nutritionals

| | | 50% reduced | |
|---|---|---|---|
| Nutrients | Control | Shortening | Units |
| Gram Weight | 100 | 100 | g |
| Calories | 313.56 | 265.08 | kcal |
| Calories from Fat | 113.23 | 65.76 | kcal |
| Calories from SatFat | 31.41 | 18.81 | kcal |
| Protein | 7.5 | 7.43 | g |
| Carbohydrates | 44.26 | 44.46 | g |
| Dietary Fiber | 2.88 | 3.91 | g |
| Soluble Fiber | 0.3 | 0.84 | g |
| Total Sugars | 11.77 | 12.04 | g |
| Fat | 12.74 | 7.39 | g |
| Saturated Fat | 3.49 | 2.09 | g |
| Trans Fatty Acid | 3.22 | 1.58 | g |

The physical appearance of the sweet rolls and the eating qualities in terms of taste, texture, and freshness throughout the products shelf life were noted to be very similar to each other.

### Example 19

### REDUCED FAT MUFFINS

In addition to making a reduced fat shortening, roll-in, or spread, expanded cell wall materials can also be used to reduced the fat in an oil. The resultant reduced fat oil has a similar consistency as a standard oil and when this is added into a formula, the resultant product has very similar eating qualities compared to the full fat oil. In this experiment, Citri-Fi™ 100 citrus fiber was used to reduce oil in a muffin formula. A Multi-Foods muffin mix (# 44812) was used in this testing and the control formula was followed according to the instructions on the bag. The formula used for the muffins is shown below:

| | Control | Test |
|---|---|---|
| Ingredient Name | Formula | Formula |
| Multi Foods cake base 44812 | 100 | 100 |
| Eggs, whole | 35 | 35 |
| Oil, veg, pure | 30 | 15 |
| Water, municipal | 22 | 22 |
| Citri-Fi ™ 100 citrus fiber | 0 | 3 |
| Blueberries, fresh, ea | 30 | 30 |
| Water, municipal | 0 | 18 |

The muffins made according to the formula above were noted to have very similar volume and eating qualities that would be difficult for a person to distinguish one from the other. Here is the nutritional information for the reduced fat muffins, which was calculated using Genesis software.

Muffin Nutritionals per 100 g

| | | 50% reduced | |
|---|---|---|---|
| Nutrients | Control | shortening | Units |
| Gram Weight | 100 | 100 | g |
| Calories | 330 | 270 | kcal |
| Protein | 4 | 4 | g |
| Carbohydrates | 40 | 41 | g |
| Dietary Fiber | 1 | 2 | g |
| Total Sugars | 24 | 24 | g |
| Fat | 18 | 11 | g |
| Saturated Fat | 3 | 2 | g |
| Trans Fatty Acid | 0 | 0 | g |

### Example 20

A cracker was made using Citri-Fi™ 100FG® fiber additive available from Fiberstar Inc. at levels of 0.75% and 1.5% of the flour weight. An additional four parts of water per part of Citri-Fi™ fiber additive were added to maintain a similar dough consistency as the control. Example formulations are shown in Table 1. Once the dough was mixed, it was formed into the shape of a cracker and baked at 450° F. for 10 minutes until brown and crisp.

TABLE 1
Example cracker formulation with Citri-Fi ™ 100 FG.

| Ingredient | Control | Test 1 | Test 2 |
|---|---|---|---|
| Flour | 100.0 | 100.0 | 100.0 |
| Sugar | 3.5 | 3.5 | 3.5 |
| Water | 27.3 | 33.0 | 30.2 |
| Yeast | 0.5 | 0.5 | 0.5 |
| Salt | 1.1 | 1.1 | 1.1 |
| Soda | 0.6 | 0.6 | 0.6 |
| Shortening | 12.1 | 12.1 | 12.1 |
| Citri-Fi ® 100 | 0.0 | 1.5 | 0.75 |
| fib. Add. FG | | | |

The crackers made using the Test 1 and Test 2 formulations were significantly stronger compared to the control. Although all crackers have similar eating qualities and taste, it was apparent that the level of Citri-Fi™ fiber additive could be used to adjust the strength of the crackers up or down. For example, in Test 1 with 1.5% Citri-Fi™ 100 FG fiber additive, the strength was noticeably increased compared to Test 2 that had a reduced 0.75% of the flour weight of Citri-Fi™ fiber additive 100 FG, while both were significantly stronger compared to the control.

### Example 21

Bagels were made with Citri-Fi® 300FG (containing citrus fiber and xanthan gum) to form a bakery product with added moistness. Additional water at 4.5 times the Citri-Fi® weight and oil at two times the Citri-Fi weight were added to the formula to help maintain dough consistency and improve moistness of the finished product. The formulas for the bagels are shown below.

| Ingredient | Control | Citri-Fi ® |
|---|---|---|
| High Gluten Flour | 100.00 | 100.00 |
| Diastatic Malt | 4.68 | 4.68 |
| Sugar | 1.56 | 1.56 |
| Water | 54.68 | 54.68 |
| Salt | 1.56 | 1.56 |
| Yeast | 1.56 | 1.56 |
| Citri-Fi 300FG | — | 1.97 |
| Water (additional) | — | 7.38 |
| Vegetable Oil | — | 3.28 |

The baked bagel product made with the additional Citri-Fi® 300FG, water, and oil was noted to have increased moistness and sensory characteristics compared to the control. Additionally, the baked characteristics in terms of volume, grain, aroma, and overall appearance were also noted to be similar for each.

### Example 22

Sugar cookies were made using the following recipe where oil was used to replace shortening and the combination of citrus fiber and a gum, Citri-Fi® 300FG fiber additive containing citrus fiber and xanthan gum in this was, was used to bind the oil so that the dough maintained a similar feel compared to the control. The benefit of the citrus fiber and gum combination is that normally when oil is used to replace shortening the dough becomes very oily and much softer. However, the expanded fiber and gum combination works well at binding the oil and giving it body so that the dough has similar body or hardness as the control as well as not being highly oily. Here is the formula.

| | Control | Citri-Fi ® |
|---|---|---|
| Item Name | (lbs) | w/ oil (lbs) |
| Sugar | 100 | 100 |
| Dry Milk | 3 | 3 |
| Salt | 4 | 4 |
| Baking Powder | 3 | 3 |
| Shortening | 125 | 0 |
| Corn Syrup | 5 | 5 |
| All Purpose Flour | 313 | 313 |
| Water | 69 | 69 |
| Oil, soybean | 0 | 125 |
| Citri-Fi 300 FG | 0 | 6 |

The finished cookies made with the oil and Citri-Fi® 300FG fiber additive were noted to be very similar compared to the control. Additionally, the test dough was noted to have similar properties as the control and not be highly oily. Using oil to replace shortening in this manner is a cost effective solution to reducing and/or eliminating both trans fatty acids as well as saturated fats in food products.

### Example 23

Biscuits were made following a standard biscuit formula as shown below. Citri-Fi 300FG fiber additive was used in combination with additional water and oil in the formula. The biscuit batter and finished biscuits were noted to be similar to each other than the finished test biscuit containing the expanded fibers and xanthan gum being more moist.

| | COMPARATIVE | | |
|---|---|---|---|
| | FORMULAS | | |
| Ingredient | Control | Test 1 | Test 2 |
| Biscuit Mix | 100.00 | 100.00 | 100.00 |
| Whole Milk | 64.12 | 64.12 | 64.12 |
| Butter | 33.90 | 33.90 | 33.90 |
| Water | — | 8.91 | 8.91 |
| Citri-Fi ® 300FG | — | | 1.98 |
| Citri-Fi ® 100FG | | 1.98 | |
| Oil | | 3.96 | 3.96 |

The hardness of the biscuits was also measured with a texture analyzer that measured the peak force to compress several biscuit samples a day after they were made. Measurements were taken of straight expanded fiber (Citri-Fi® 1 OOFG in this case) as well a combination product consisting of citrus fiber and xathan gum (Citri-Fi® 300FG in this case).

| | Peak Force |
|---|---|
| Sample ID | (gms) |
| Control | 1823 |
| 1% C.F. 100 FG × 2 Oil (test 1) | 1541.4 |
| 1% C.F. 300 FG × 2 Oil (test 2) | 1507.6 |

The results show a softness benefit when the citrus fiber alone (test 2) was added along with additional water and oil but not to the same degree as when the combination product of expanded fiber and xanthan gum are added (test 2).

### Example 24

An unique application of the expanded fiber and gum mixture is to form a uniform emulsion out of oil and water mixture. In this example water, oil and the expanded fiber and/or gum was mixed using high shear into a solution to form an emulsion. The emulsion was allowed to sit out to see if the oil separated from the water as a way to evaluation the emulsifying properties of the expanded fiber and/or gum combination.

| Ingredient | Control (g) | Test 1 (g) | Test 2 (g) | Test 3 (g) |
|---|---|---|---|---|
| Oil | 30 | 30 | 30 | 30 |
| Water | 70 | 70 | 70 | 70 |
| Citri-Fi ® 300FG | 0 | 1 | 0 | 0 |
| Citri-Fi ® 100FG | 0 | 0 | 1 | 0 |
| Xanthan gum | 0 | 0 | 0 | 1 |

The results on the solutions are shown in the table below. The sample with the least amount of separation was Test 1, which tended to hold the oil and water solution in over an extended period of time.

| Sample | Separation Comments |
|---|---|
| Control | Clear line of separation |
| Test 1 | Completely emulsified solution |
| Test 2 | Initially completely emulsified, but separates after 2 days |
| Test 3 | Forms pockets or globules of fat that tend to separate out |
| | in solution |

### Example 25

Citri-Fi® products could be dry blended with a commercially available sterol using dry blending equipment at a ratio of 50% plant sterols and 50% Citri-Fi® 100FG. The finished product would be a nutraceutical composition that has a high water absorption and surface area along with the ability to reduce cholesterol when added at a rate of near 1% in a finished food product. For an example muffin with a serving size of 60 grams and 1% inclusion, this would mean 0.3 g of the plant sterol would be consumed along with 0.3 grams of dried citrus fiber.

### Example 26

Undried citrus pulp with a solids content near 10% could be co-processed with plant sterols using an IKA mixer (Wilmington, N.C.) that helps to infuse the plant sterols into the hydrated citrus fiber structure followed by drying this hydrated mass. The estimate ratio would be 50% (dry basis) plant sterols with 50% (dry basis) citrus fiber. Upon drying, the co-processed plant sterols would likely be physically attached to the citrus fiber to make a co-processed and co-dried finished product that contains 50% plant sterols with 50% citrus fiber. For an example cake with a serving size of 60 grams made with this example nutraceutical food ingredient at 1% inclusion, this would mean 0.3 g of the plant sterol would be consumed along with 0.3 grams of dried citrus fiber.

### Example 27

Citri-Fi® 200FG products containing citrus fiber and guar gum could be dry blended with a commercially available sterol using a dry blending equipment at a ratio of 50% plant sterols and 50% Citri-Fi® 100FG. The finished product would be a nutraceutical composition that has a high water absorption and surface area along with the ability to reduce cholesterol when added at a rate of near 1% in a finished food product. For an example muffin with a serving size of 60 grams, this would mean 0.3 g of the plant sterol would be consumed along with 0.3 grams of dried citrus fiber and guar gum.

### Example 28

Undried citrus pulp with a solids content near 10% could be co-processed with omega 3 oil using an IKA mixer (Wilmington, N.C.) that helps to infuse the omega 3 oil into the hydrated citrus fiber structure followed by drying this hydrated mass. The estimate ratio would be 50% omega 3 oil with 50% (dry basis) citrus fiber. Upon drying, the co-processed omega-3 oil would likely be physically entrapped to the citrus fiber to make a co-processed and co-dried finished product that contains 50% omega 3 oil with 50% citrus fiber. For an example bread with a serving size of 56 grams made with this example nutraceutical food ingredient and 1% inclusion, this would mean 0.28 g of the plant sterol would be consumed along with 0.28 grams of dried citrus fiber.

### Example 29

To increase the dose and have consumers ingest the expanded fiber as a concentrated form, Citri-Fi® 100FG could be packed into a tablet and with or without a plant sterol and this combination of both the form of the pill and the nutraceutical would be able to deliver a unique combination of satiety from the fiber materials and a disease prevention benefit from the sterol. The combination would provide consumers with a easy way to reduce weight and prevent disease.

### Example 30

Undried microfibrillated cellulose as found in Turbak patents (U.S. Pat. No. 4,378,381, and U.S. Pat. No. 4,374,702) with a solids content near 5% could be co-processed with omega 3 oil using an IKA mixer (Wilmington, N.C.) that helps to infuse the omega 3 oil into the microfibrillated cellulose structure followed by drying this hydrated mass. The estimate ratio would be 50% omega 3 oil with 50% (dry basis) microfibrillated cellulose. Upon drying, the co-processed omega-3 oil would likely be physically entrapped to the microfibrillated fiber to make a co-processed and co-dried finished product that contains 50% omega 3 oil with 50% microfibrillated cellulose. For an example bread with a serving size of 56 grams made with this example nutraceutical food ingredient and 1% inclusion, this would mean 0.28 g of the plant sterol would be consumed along with 0.28 grams of microfibrillated cellulose.

The concept of nutraceuticals is capable of debate and conflicting definition. There has therefore been an attempt to define the terminology in the field as follows. The term “nutraceutical” was coined from “nutrition” and “pharmaceutical” in 1989 by Stephen DeFelice, MD, founder and chairman of the Foundation for Innovation in Medicine (FIM), Cranford, N.J.¹ According to DeFelice, nutraceutical can be defined as, “a food (or part of a food) that provides medical or health benefits, including the prevention and/or treatment of a disease.”¹ However, the term nutraceutical as commonly used in marketing has no regulatory definition.² It has been proposed to redefine functional foods and nutraceuticals. When food is being cooked or prepared using “scientific intelligence” with or without knowledge of how or why it is being used, the food is called “functional food.” Thus, functional food provides the body with the required amount of vitamins, fats, proteins, carbohydrates, etc, needed for its healthy survival. When functional food aids in the prevention and/or treatment of disease(s) and/or disorder(s) other than anemia, it is called a nutraceutical. (Since most of the functional foods act in some way or the other as antianemic, the exception to anemia is considered so as to have a clear distinction between the two terms, functional food and nutraceutical.) Thus, a functional food for one consumer can act as a nutraceutical for another consumer. Examples of nutraceuticals include fortified dairy products (eg, milk) and citrus fruits (e.g., orange juice). The DSHEA formally defined “dietary supplement” using several criteria. A dietary supplement³:
is a product (other than tobacco) that is intended to supplement the diet that bears or contains one or more of the following dietary ingredients: a vitamin, a mineral, an herb or other botanical, an amino acid, a dietary substance for use by man to supplement the diet by increasing the total daily intake, or a concentrate, metabolite, constituent, extract, or combinations of these ingredients.
is intended for ingestion in pill, capsule, tablet, or liquid form.
is not represented for use as a conventional food or as the sole item of a meal or diet.
is labeled as a “dietary supplement.”
includes products such as an approved new drug, certified antibiotic, or licensed biologic that was marketed as a dietary supplement or food before approval, certification, or license (unless the Secretary of Health and Human Services waives this provision).

Thus, nutraceuticals (as per the proposed definition) differ from dietary supplements in the following aspects:
Nutraceuticals must not only supplement the diet but should also aid in the prevention and/or treatment of disease and/or disorder.
Nutraceuticals are represented for use as a conventional food or as the sole item of meal or diet.

A ray of “cure preference” in the mind of common patients revolves around nutraceuticals because of their false perception that “all natural medicines are good.” Also, the high cost of prescription pharmaceuticals and reluctance of some insurance companies to cover the costs of drugs helps nutraceuticals solidify their presence in the global market of therapies and therapeutic agents. The use of nutraceuticals, as an attempt to accomplish desirable therapeutic outcomes with reduced side effects, as compared with other therapeutic agents has met with great monetary success.^{4,5} The preference for the discovery and production of nutraceuticals over pharmaceuticals is well seen in pharmaceutical and biotechnology companies.

However, with all of the aforementioned positive points, nutraceuticals still need support of an extensive scientific study to prove “their effects with reduced side effects.”^{6,7} This can be achieved by the enactment of FIM proposed Nutraceutical Research and Education Act (NREA).⁸ The NREA includes the creation of a Nutraceutical Commission (NUCOM) specifically for the review and approval of nutraceuticals and the creation of a nutraceutical research grants program specifically for clinical research. As per FIM, the key elements of NREA should include a mechanism to create the exclusive rights to claims necessary for private investment in research and development, and the creation of appropriate channels for the review, approval, and regulation of new products and claims. We believe that in so doing the NREA should keep in check the cost of nutraceuticals and thereby assure access for everyone. (Citations—1. Brower V. Nutraceuticals: poised for a healthy slice of the healthcare market? Nat Biotechnol. 1998; 16:728-731; 2. Zeisel SH. Regulation of “Nutraceuticals.” Science. 1999; 285:185-186. 3. FDA/CFSAN resources page. Food and Drug Administration Web site. Dietary Supplement Health and Education Act of 1994. Available at: http://vm.cfsan.fda.gov/˜dms/dietsupp.html. 4. Nelson N J. Purple carrots, margarine laced with wood pulp? Nutraceuticals move into the supermarket. J Natl Cancer Inst. 1999; 91:755-757. 5. Whitman M. Understanding the perceived need for complementary and alternative nutraceuticals: lifestyle issues. Clin J Oncol Nurs. 2001; 5:190-194. 6. Heyland D K. In search of the magic nutraceuticals: problems with current approaches. J Nutr. 001; 131(9):2591S-2595S. 7. Elizabeth A C. Over-the-counter products: nonprescription medications, nutraceuticals, and herbal agents. Clin Obstet Gynecol. 2002; 45(1):89-98. 8. DeFelice SL. FIM Rationale and Proposed Guidelines for the Nutraceutical Research & Education Act—NREA, Nov. 10, 2002. Foundation for Innovation in Medicine. Available at: http://www.fimdefelice.org/archives/arc.researchact.html.

In summation, a nutraceutical is an ingredient added to food materials to enhance purported or asserted health benefits, as opposed to merely using foods that contain natural quantities of healthful additives.

1. An edible food product comprising at least a) 0.05%-5% by total weight highly refined cellulose product defined by a fiber material that has a total dietary fiber (TDF) content greater than 30% as measured by AOAC 991.43 and a water holding capacity greater than five parts water per part fiber as measured by AACC 56-30 and comprises less than 90% soluble fiber, and at least b) 0.05% by total weight of a nutraceutical.

2. The edible food product of claim 1 wherein the highly refined cellulose (HRC) has a lignin concentration of at least 1% by weight and a water retention capacity of at least about 20 g H₂O/g dry HRC.

3. The edible food product of claim 2 wherein the HRC has an oil retention capacity of at least about 10 g/g dry HRC.

4. The edible food product of claim 2 wherein the HRC is dehydrated or a dispersion.

5. The edible food product of claim 2 wherein the HRC has a Langmuir surface area of at least about 7 m²/g.

6. The edible food product of claim 2 wherein the HRC has an average pore diameter of at least about 5 angstroms.

7. The edible food product of claim 1 wherein the nutraceutical is provide an expectation of a health benefit selected from the group consisting of:
a. Antioxidation;
b. Cancer prevention;
c. Arterial health improvement;
d. Cholesterol lowering;
e. Reduced blood pressure;
f. Skin and wrinkle treatment; and
g. Prolonging and/or delaying release of a nutrient into the bloodstream.

8. The edible food product of claim 2 wherein the nutraceutical is provide an expectation of a health benefit selected from the group consisting of:
a. Antioxidation;
b. Cancer prevention;
c. Arterial health improvement;
d. Cholesterol lowering;
e. Reduced blood pressure; and
f. Skin and wrinkle treatment.

9. The edible food product of claim 1 wherein the nutraceutical is selected from the class consisting of: 1) gastrointestinal agents; 2) antibiotics; 3) antiviral agents; 4) antifungal agents 5) antineoplastic agents; 6) analgesics; 7) tranquilizers; 8) narcotic antagonists; 9) antidepressants; 10) antihistamines; 1) antimigraine; 12) cardiovascular drugs; 13) calcium channel blockers; 14) appetite suppressant; 15) contraceptive agents; 16) corticosteroids; 17) local anaesthetics; 18) diuretics; 19) antihypertensive agents; 20) steroids; 21) prostaglandins; 22) anti-inflammatory drugs; 23) antithrombotic agents; 24) cardiac glycosides; 25) antiparkinsonism drugs; 26) chemical dependency drugs; and 27) peptides.

10. The edible food product of claim 2 wherein the nutrceutical is selected from the classes consisting of: 1) gastrointestinal agents; 2) antibiotics; 3) antiviral agents; 4) antifungal agents 5) antineoplastic agents; 6) analgesics; 7) tranquilizers; 8) narcotic antagonists; 9) antidepressants; 10) antihistamines; 11) antimigraine; 12) cardiovascular drugs; 13) calcium channel blockers; 14) appetite suppressant; 15) contraceptive agents; 16) corticosteroids; 17) local anaesthetics; 18) diuretics; 19) antihypertensive agents; 20) steroids; 21) prostaglandins; 22) anti-inflammatory drugs; 23) antithrombotic agents; 24) cardiac glycosides; 25) antiparkinsonism drugs; 26) chemical dependency drugs; and 27) peptides, 28) energy supplements.

11. A method of providing a mass an edible food product comprising providing:
a) 0.05%-5% by total weight highly refined cellulose product (HRC) having a lignin concentration of at least 1% by weight and a water retention capacity of at least about 20 g H₂O/g dry HRC, and blending or mixing a) with b) a nutriceutical to form an edible mass.

12. The method of claim 11 wherein the edible mass is added to gluten products to form a cookable mass and the cookable mass is cooked to provide a consumable product.

13. The method of claim 12 wherein the HRC has an oil retention capacity of at least about 10 g/g dry HRC.

14. The method of claim 11 wherein the HRC is dehydrated or a dispersion.

15. The method of claim 11 wherein the HRC has a Langmuir surface area of at least about 7 m²/g.

16. The method of claim 11 wherein the nutraceutical is provide an expectation of a health benefit selected from the group consisting of:
a. Antioxidation;
b. Cancer prevention;
c. Arterial health improvement;
d. Cholesterol lowering;
e. Reduced blood pressure;
f. Skin and wrinkle treatment; and
g. prolonging and/or delaying release of a nutrient into a bloodstream.

17. The method of claim 11 wherein the nutrceutical is selected from the classes consisting of: 1) gastrointestinal agents; 2) antibiotics; 3) antiviral agents; 4) antifungal agents 5) antineoplastic agents; 6) analgesics; 7) tranquilizers; 8) narcotic antagonists; 9) antidepressants; 10) antihistamines; 11) antimigraine; 12) cardiovascular drugs; 13) calcium channel blockers; 14) appetite suppressant; 15) contraceptive agents; 16) corticosteroids; 17) local anaesthetics; 18) diuretics; 19) antihypertensive agents; 20) steroids; 21) prostaglandins; 22) anti-inflammatory drugs; 23) antithrombotic agents; 24) cardiac glycosides; 25) antiparkinsonism drugs; 26) chemical dependency drugs; and 27) peptides.

18. A method of improving the health or well-being of an animal comprising providing the food product of claim 1 to an animal and the animal ingesting the food product.

19. An edible dietary supplement or tablet product comprising at least a) 0.05%-5% by total weight highly refined cellulose product defined by a fiber material that has a total dietary fiber (TDF) content greater than 30% as measured by AOAC 991.43 and a water holding capacity greater than five parts water per part fiber as measured by AACC 56-30 and comprises less than 90% soluble fiber, and at least b) 0.05% by total weight of a nutraceutical.

20. The edible dietary tablet of claim 19 further comprising a plant sterol.
